(19) United States
(12) Patent Application Publication
(10) Pub. No.: US 2014/0282470 A1
(43) Pub. Date: Sep. 18, 2014

(54) REMOTE TRANSFER OF ELECTRONIC IMAGES TO A VEHICLE

(71) Applicant: Arynga Inc., La Jolla, CA (US)

(72) Inventors: Walter Buga, Rancho Santa Fe, CA (US); Bartlomiej Jozwiak, Lodz (PL); Bartlomiej Swiercz, Lodz (PL); Maciej Zenon Borzecki, Lodz (PL)

(73) Assignee: Arynga Inc., La Jolla, CA (US)

(21) Appl. No.: 14/205,068

(22) Filed: Mar. 11, 2014

Related U.S. Application Data
(60) Provisional application No. 61/779,026, filed on Mar. 13, 2013.
(60) Provisional application No. 61/827,662, filed on May 26, 2013.
(60) Provisional application No. 61/887,436, filed on Oct. 6, 2013.

(51) Int. Cl. G06F 9/445; G06F 9/44

(52) U.S. Cl. CPC G06F 8/65; G06F 8/71
USPC 717/170

(57) ABSTRACT

Described are systems and methods for transmission of data between one or more vehicles and a control apparatus (e.g., server or other computing device). In particular, the invention relates to systems, methods and computer program products for over-the-air transmission of electronic images (EIs) between one or more vehicles and a control sub-system. The inventions also relates to a standardized methodology and system for implementation of remote EI updates.

### CROSS-REFERENCE TO RELATED APPLICATIONS

This application claims priority under 35 U.S.C. §119(e) to co-pending U.S. Provisional Patent Application No. 61/779,026, filed Mar. 13, 2013, entitled REMOTE TRANSFER OF ELECTRONIC IMAGES TO A VEHICLE, the content of which is hereby incorporated by reference herein in its entirety for all purposes.

This application claims priority under 35 U.S.C. §119(e) to co-pending U.S. Provisional Patent Application No. 61/827,662, filed May 26, 2013, entitled REMOTE TRANSFER OF ELECTRONIC IMAGES TO A VEHICLE, the content of which is hereby incorporated by reference herein in its entirety for all purposes.

This application claims priority under 35 U.S.C. §119(e) to co-pending U.S. Provisional Patent Application No. 61/887,436, filed Oct. 6, 2013, entitled REMOTE TRANSFER OF ELECTRONIC IMAGES TO A VEHICLE, the content of which is hereby incorporated by reference herein in its entirety for all purposes.

### FIELD

The invention relates generally to systems, methods and computer program products for transmission of data between one or more vehicles and a control apparatus. In particular, the invention relates to systems and methods for over-the-air transmission of electronic images (EIs) between one or more vehicles and a control sub-system. The inventions also relates to a standardized methodology and system for implementation of remote EI updates.

### BACKGROUND

Current methodologies for updating electronic images (EIs) in the automotive industry are inefficient, ineffective, inconvenient and infrequent. Accordingly, a solution is needed that provides for greater efficiency, effectiveness, convenience and frequency of updating EIs.

### SUMMARY

Certain embodiments of this disclosure relate generally to networks, devices, methods and computer-readable medium for providing updates to an automotive electronics system residing at a motorized vehicle. Such networks, devices, methods and computer-readable medium may identify a first set of update files received by the automotive electronics system from an external source during a first period of time, and identifying a second set of installed files that correspond to the update files of the first set. For each update file of the first set that corresponds to an installed file of the second set, the networks, devices, methods and computer-readable medium may cause that update file to replace that installed file only when a version of the update file is different that a version of the installed file.

### DRAWINGS

FIG. 1 depicts backend system.

FIG. 2 depicts vehicle system.

FIG. 3 depicts a proxy server system.

FIG. 4 depicts a process for updating and transmitting an electronic image (EI).

FIG. 5 depicts a process for downloading a release package.

FIG. 6 depicts aspects related to decryption and validation of contents of a release package.

FIG. 7 depicts aspects related to a vehicle domain script.

FIG. 8 depicts aspects related to a release package script.

FIG. 9 depicts aspects related to an update script.

FIG. 10 depicts aspects related to a vehicle sub-domain script.

FIG. 11 illustrates a system for transmission of an EI.

FIG. 12A illustrates a system for transmission of an EI.

FIG. 12B illustrates a logical connection between the cloud and the vehicle.

FIG. 13 illustrates a system for transmission of an EI.

FIG. 14 illustrates a system for transmission of an EI.

FIG. 15 illustrates a process for transmitting an EI to a vehicle.

FIG. 16 illustrates system architecture.

FIG. 17 illustrates a system for transmission of an EI to a vehicle using a smart phone.

FIG. 18 depicts an ECU release package object.

FIG. 19 depicts a vehicle cluster release package object.

FIG. 20 depicts a vehicle release package object.

FIG. 21 depicts an OEM cloud server and database architecture.

FIG. 22 depicts vehicle components.

FIG. 23 depicts aspects related to a release package update script.

FIG. 24 depicts aspects related to updating an EI within an ECU.

FIG. 25 depicts aspects related to an release package update script

FIG. 26 depicts aspects related to updating an EI within an ECU.

FIG. 27 depicts aspects related to downloading an EI to an ECU.

FIGS. 28A-B illustrate a cloud-based system.

FIG. 29 depicts aspects relating to release package updates.

FIG. 30 depicts aspects relating to a Logical release package.

FIG. 31 depicts aspects relating to a release package for firmware and software.

FIG. 32 depicts aspects relating to firmware and software release packages.

FIG. 33 depicts aspects relating to release package update scenarios.

FIG. 34 depicts aspects relating to release package updates with freeze points.

FIG. 36 depicts aspects relating to an update overview.

FIG. 37A-F depicts a general update file format and blocks.

FIG. 38 depicts a general update file format.

FIG. 39 depicts aspects relating to a general view of update structures.

FIG. 40 depicts aspects relating to a release package.

FIG. 41 depicts aspects relating to a Logical Update File.

FIG. 42 depicts aspects relating to calling scripts during update process.

FIG. 43 depicts a Partial Message Communication.

FIG. 44 depicts aspects relating to blocking a state in a Vehicle State Manager.

FIG. 45 depicts aspects relating to querying a Vehicle State Manager for current state.

FIG. 46 depicts aspects relating to firmware and software release packages.

FIG. 47 depicts aspects relating to administrator and update manager interaction.

FIG. 48 depicts a distributive architecture solution.

FIG. 49 depicts a backend implementation.

FIG. 50 shows an architecture that are scalable and deployed as a cluster/cloud.

FIG. 51 shows a general architecture of the Backend

FIG. 52 depicts encryption architecture.

FIG. 53 illustrates aspects related to encryption.

FIG. 54 illustrates aspects related to encryption.

FIG. 55 illustrates aspects related to a test server.

FIG. 56 illustrates a Data Reporting and Report Queue.

FIG. 57 illustrates a Request Data Queue.

FIG. 58 illustrates a Notification Queue.

FIG. 59 illustrates component responsibilities in an exchanging subsystem.

FIG. 60 depicts a RabbitMQ Communication Path.

FIG. 61 depicts a Download Controller Component.

FIG. 62 depicts a CarInfo Controller Component.

FIG. 63 depicts a RepoUpdate Controller Component

FIG. 64 depicts a vehicle environment.

FIG. 65 depicts a Script Flow Diagram.

FIG. 66 depicts an Update Script Flow Diagram.

FIG. 67 depicts an EI Successful Update.

FIG. 68 depicts an update procedure.

FIG. 69 depicts a successful update of an EI.

FIG. 70 depicts an Update Procedure Sequence Diagram.

FIG. 71 depicts an update sequence diagram.

FIG. 72 depicts an unsuccessful updateof an EI.

### DETAILED DESCRIPTION

Various aspects of the invention may be described below. It should be apparent that the teachings herein may be embodied in a wide variety of forms and that any specific structure, function, or both, being disclosed herein may be merely representative. Based on the teachings herein one skilled in the art should appreciate that any aspect disclosed may be implemented independently of any other aspects and that two or more of these aspects may be combined in various ways. For example, a system may be implemented or a method may be practiced using any number of the aspects set forth herein.

Aspects and features of the invention may be designed to operate on computer systems, servers, and/or other like devices. While the details of the embodiments of the invention may vary and still be within the scope of the claimed invention, one of skill in the art will appreciate that the figures described herein may be not intended to suggest any limitation as to the scope of use or functionality of the inventive aspects. Neither should the figures and there description be interpreted as having any dependency or requirement relating to any one or combination of components illustrated in those figures.

Certain aspects of the invention provide automotive OEMs and Tier 1 suppliers (Tier 1) with a seamless and customizable solution for remotely maintaining and updating all electronic images (EIs) residing in Electronic Control Units (ECUs). As used herein, an EI may be defined to be any unique sequence of bits that may be logically separated for a specific use within an embedded device (e.g., an ECU). Examples of EIs include executable images, script files, configuration data, PLD executable images, html files, and other related types of executable and/or data files. One of skill in the art will appreciate that the teachings herein apply to various types of data apart from the EIs listed herein.

An ECU may be a physically-distinct and self-enclosed electronic hardware component that provides some predefined set of functionality to the vehicle. As one of skill in the art can appreciate, ECUs and EIs designed and used by certain OEMs and Tier 1 may differ from ECUs and EIs designed and used by other OEMs and Tier 1. Accordingly, certain aspects of the disclosure provide for customization across various ECUs and EIs. For example, fields may be customizable in the sense that many fields may be optional so that the same functionality can be supported regardless of which fields may be active for a given OEM or Tier 1.

Aspects of the invention further provide a data transfer between a configuration server (e.g., a Vehicle Configuration Cloud Server (VCCS) operated by an OEM and/or one or more other entities) to an individual ECU for a specific vehicle. The configuration server/VCCS may hold all of the combinations of ECU release packages. The data may transfer using one or more of various networks, including the Internet, local area networks (e.g., LAN, WiLAN, Wi-Fi, Bluetooth), cellular or other over-the-air (OTA) wireless carrier pathways, satellite pathways, and/or other wired and wireless communication pathways. Additional transport pathways include the SIRIUSXM communication pathways and ONSTAR communication pathways, among other pathways that may be specific to transfer of data to and/or from a vehicle.

By way of example, a downlink pathway (e.g., one used for SIRIUSXM satellite radio) may be used to transfer one or more EIs to a vehicle. Such a satellite pathway may provide for enough bandwidth to effectively carryout the transmission over a reasonable time period and at many locations (e.g., including locations that may be out of range of other pathways). One-way satellite downloads may be accomplished using scheduled broadcasts for vehicles of a specific make, model, and year. In some instances, broadcasts may need to be repeated. Although very large downloads like those for updating maps may be better suited for update either via USB or a two-way communication method of transfer, satellite broadcasts may also be used. Thus, an intelligent arbitration scheme may be needed at the Cloud Gateway Interface (CGI) that determines the specific mechanism for downloading according to a set of preset decision criteria.

It may be contemplated that two-way and one-way communication links may be used, and that channels of various bandwidth may be used. For a nominal download case involving standard or known ECUs at the vehicle and/or standard RPs, two-way communication may be not absolutely necessary provided that sufficient verification information may be contained within the downloaded information in a manner similar to the necessary checks and balances that may be implemented for updates residing on a physical medium (e.g., USB Flash Drive, CD/DVD, or other components with memory). Two-way communication may become necessary where For example, vehicles include ECUs, other components and RPs that deviate from standard or known ECUs, other components and RPs. In such an instance, differences in data transfer may need to be carried out using a two-way communication pathway (e.g., transparently through a variety of means such as the vehicle owner's home Wi-Fi network), and that pathway may or may not require real-time transfer of data. Two-way communication may also be required where an OEM wishes to maintain a physical record of each individual vehicle, at which point a confirmation of the updates may be returned to the VCCS from the vehicle. However, such confirmation messages may be not required to occur in real time and may be indefinitely postponed until a convenient time in the future. Two-way communication may be further required where the VCCS or other component external to the vehicle processes error status information. Two-way communication pathways also permit transfer of other information from the vehicle to the VCCS or other component external to the vehicle.

In most instances, e.g., where standard or known ECUs may be involved, a one-way communication pathway like a satellite downlink may be sufficient. The data may be packaged pursuant to various standards, protocols and methodologies of those pathways. Downlink communications to a vehicle ma specify various information, including a channel from which an EI may be received, the EI, instructions, and information necessary for successful maintenance of EIs.

Whether one-way or two-way communication may be used, the EI may be downloaded to the appropriate ECU following completion and verification of the EI's download from the network. Historic transactional information may be subsequently stored within the ECU containing the Logical Vehicle Compartment (LVC) Configuration Server (CS) for future reference and upload to an external configuration server such as the OEM VCCS or a user specified Vehicle Configuration Proxy Server.

It may be further contemplated that data may be delivered from and/or to a personal computer (e.g., a smart phone or home computer connected to the vehicle and running a local “Proxy Configuration Server”), an official Configuration Server in communication with the vehicle at a dealer or other authorized location, another vehicle connected to the vehicle, a USB connected to the vehicle, or other component with memory and/or processing capabilities that may be connected to the vehicle. The data may also transfer through various components in the vehicle, including the vehicle's Vehicle Gateway Server (VGS). One of skill in the art will appreciate that connection between an OEM's VCCS and the vehicle's ECU may depend upon the OEM's implementation of the AUTOSAR standard Unified Diagnostic Service (UDS) ECU programming protocol.

In accordance with yet another aspect of the invention, transfer of data between the VCCS and the ECU can carried out in a safe, secure, reliable, and flexible manner. For example, the transfer may be safe in that no EI may be downloaded until it has been verified as the correct EI for the specific ECU subcomponent. CRC checks and other release version related compatibility checks may be used to verify the EI for the ECU. Moreover, the transfer may be secure in that the data may be sent utilizing IP Security across the Internet cloud and WiFi Protected Access across any Wi-Fi network on the vehicle-side of the data transfer. The transfer may be reliable in that data aggregation may be used, which allows for as many multiple sessions as required in order to aggregate and accurately reassemble a single release package of information or set of release packages. A release package (RP) may be a sequential linearly stored data object comprised of descriptive information, configuration data, executable scripts, and EIs (EIs) needed for a specific physical entity (such as an ECU) or logical entity (an entire LVC).

The transfer may be flexible in that the configuration of the record structure utilizes optional fields and/or mandatory fields as opposed to only mandatory fields in its ECU EI and RP configuration database design. Further flexibility may be available in that the transfer may occur over a variety of transport mediums between the VCCS and individual Vehicle Gateway Interfaces. A Vehicle Gateway Interface (VGI) may be a communication interface at a vehicle to external components for which all LVC Configuration Servers must interface with in order to communicate with the VCCS.

In accordance with yet another aspect, the invention may provide for a complete Configuration Management System (CMS) and delivery methodology for updating ECU EIs that provides both ends of the configuration link and a methodology enabling complete connectivity between both ends regardless of the communication pathway(s). In accordance with at least some embodiments, end-point components like an OEM VCCS and the LVC Configuration Server within the vehicle, or intermediary components, may be unaware of the pathway supplying the data. Of course, other components may be away of the pathway(s) used to deliver the data, including such other components as the VGI.

Similarly, the components may be unaware of the methodology used to transport the data (e.g., so long as the inward facing ports have been implemented to allow downloading sessions to pause and resume across a series of multiple connections). Accordingly, as data transfer technologies and methodologies evolve, the inventive solutions described herein may evolve with those technologies/methodologies. It may be contemplated that various technologies be used, including differential engine technology of Red Bends.

Attention may be now given to particular embodiments of the invention as described below.

### Data Transfer in Certain Embodiments

Attention may be now drawn to FIG. 1, which depicts architecture for managing and carrying out the transfer of data among various components, and illustrates various pathways for transferring data among those components. The system of FIG. 1 may be used, for example, to enable universal remote updating of EI's across the automotive OEM and Tier 1 marketplace.

The system depicted in FIG. 11 may take various configurations within the scope and spirit of the invention. For example, the disclosed system shown in FIG. 1 may be configured to include one or more VCCSs, a network cloud consisting of any sort of network/communication pathway, a vehicle gateway interface (VGI) at the vehicle or in communication with the vehicle (e.g., a transceiver for receiving and transmitting data, including an on-board WiFi transceiver, an on-board satellite transceiver, an on-board radio frequency/cellular transceiver, an external personal computer (e.g., smart phone), etc.). As shown, the VGI may directly or indirectly communicate with one or more configuration servers at the vehicle, including an engine bay configuration server, a chassis configuration server, an infotainment configuration server, and a telematics configuration server. Each configuration server, which may be a standalone device or embedded within an existing module, may communicate directly or indirectly with one or more ECUs. One of skill will appreciate that some components may be omitted for certain embodiments. For example, the configuration servers may be omitted, and the transceivers may connect directly to the ECUs.

The VCCS may be configured to maintain a database (not shown) of EIs associated with different vehicles (e.g., according to according to make, model, and year) and different ECUs. Accordingly, the OEMs may provide the VCCS. Alternatively, a third party may maintain the VCCS. The database or portions of it may be alternatively or also hosted at a location apart from the VCCS, including a personal computer of a vehicle owner, an authorized distributor of EIs, or another entity. EIs may be downloaded by these other entities using the network cloud of FIG. 1.

A database at or connected to the VCCS may store EIs in the form of RPs across various vehicles manufactured by particular OEMs and the ECUs associated with eh EIs. The RP may be defined to be the complete collection of EIs according to a specified delineation. The databases may also store vehicle history and other information about the vehicle.

The VCCS may also monitor information received from the vehicle in order to determine if a modification to the EI or a new EI may be needed, and then may transmit the modification or new EI to the vehicle. Thus, corrupt, malfunctioning, or impaired performance of the ECU or other component may be detected in real time, and a fix may be sent to the vehicle.

Attention may be turned to FIG. 12A, which illustrates the relationship between the VCCS and the VGI. As shown, the VCCS communicates to the vehicle via any one of a number of mediums and passes through the VGI. The VGI may and probably will vary from OEM to OEM, and may be customized accordingly. However, it must functionally interface on both data interfaces with the VCCS operates and the LVC-CS, respectively.

A Cloud Gateway Interface (CGI) may manage the data communication links between the VCCS and the LVC-CS via the VGI. ECU. The CGI may be an abstraction layer for a VCCS. As an abstraction layer, it may be highly dependent upon the operating system utilities and features available to it on the physical layer of its interface. Its primary responsibility may be to manage the physical connection between itself and its counterpart VGI on the other end of the pipe. By setting up and managing the physical connection between the two ends, it thus enables a data path for the VCCS.

FIG. 12B illustrates a logical connection between the cloud and the vehicle. As shown a Cloud Connection Manager (CCM) manages the logical connection between itself and counterpart Connection Manager on the other end of the pipe (e.g., the Vehicle Cluster Connection Manager). By setting up and managing the physical connection between the two ends, it thus enables a communication path for any component that sits on top of it (e.g., a VCCS Database Manager (VCCS-DM) (not shown)). As part of its duties for providing the logical connection, the CCM: notifies individual Vehicle Cluster Connection Managers when updates may be available; establishes connections with the individual Vehicle Cluster Connection Manager within individual vehicles upon request (e.g., via a two-way communication data link); establishes broadcast connections when necessary and/or desired (e.g., notifications to all owners of a particular make, model, and year that a specific update may be available); and monitors the progress of the update, including the number of bytes for tracking the extent of any one download.

A VCCS Database Manager (VCCS-DM) (not shown) may manage any or all of the databases, including: the Electronic Image database; the ECU release package database; the Vehicle Cluster release package database; and/or the Vehicle release package database. These databases may be built and maintained using SQLite, as mandated by GENIVI. (Note—more information on the SQLite software library may be found at, http://www.sqlite.org). The primary duties of VCCS-DM may include maintaining and updating any/all of the databases, and notifying the CCM whenever new updates may be available.

A VCCS Web Interface (not shown) may provide an HTML interface to the databases (e.g., at an OEM data center). The Web Interface may provide a manual method for updating and maintaining individual databases (e.g., within a Linux Server). The primary duties of this interface may include: providing mechanism for adding new objects to each database; providing mechanism for updating existing objects within each database; notifying the CCM when changes have been to the databases with the expectation being that the CCM will in turn notify individual vehicles; and providing user with ability to monitor progress of database updates and individual vehicle update status.

Attention may be now turned to FIG. 13, which depicts a Vehicle Configuration Proxy Server (VCPS) that acts as a “proxy” to the VCCS in lieu of the VGI, and conversely acts as a “proxy” to the VGI in lieu of the VCCS. Use of a VCPS permits indirect downloads of EIs where transmission of the EI takes an intermediary path to the VCPS and then eventually to the vehicle. This scheme may be designed such that the VCCS has no knowledge as to whether it may be communicating to the actual vehicle or in this case, a proxy for the vehicle. Thus, the VCCS may remain unchanged in its implementation to either the VCPS or the LVC-CS (via the VGI). This means that the interface between the VCPS and the VCCS may behave in the same manner as the interface between the VGI and the VCCS, and that the interface between the VCPS and the VGI may behave in the same manner as the interface between the VGI and the VCCS.

The VCPS must essentially behave the same way as the VCCS apart from spoofing different interfaces as described above. One caveat, however, may be that unlike the VCCS, which may have information on a great number of makes and models for various vehicles, the VCPS may be limited to only the information on one or more specific vehicles that may be associated with the VCPS (e.g., vehicles whose make, model, year, and VIN have been entered into its database). For instance, where the VCPS may be a personal computer of a vehicle owner, that VCPS may only have information associate with that vehicle.

Attention may be now drawn to FIG. 14, which depicts a VGI that may be located within a vehicle and may be that vehicle's portal to the network cloud. The VGI may have various interfaces, including an interface for the network cloud and the ECUs for each individual LVC and the corresponding configuration server. In many cases, the VGI resides in one of the primary ECUs (e.g., in either the primary ECU for Telematics or Infotainment), and therefore resides within the same physical hardware as an LVC-CS. One of skill in the art will appreciate variations to this setup.

The LVC-CS may be the configuration server to all of the ECUs within its domain. This software object usually resides within a master ECU. The LVC-CS may maintain the client to the VCCS as well as the Configuration Server for the LVC for which it may be responsible. The LVC-CS may further be responsible for managing the RPs of all ECUs within its domain, including itself.

The LVC-CS may act as a client to the external configuration server from which it obtains its updates, and may be unaware as to which Configuration Server it may be actually communicating to and may be not aware of whether or not it may be communicating directly to the VCCS, a VPCS in a Wi-Fi network or other communication pathway. It may be completely ambivalent as to where the RP may be obtained, and may be only concerned with whether or not the RP and its contents may be valid.

The LVC-CS may optionally maintain a complete history of updates for the ECUs and their EIs within its domain, at least one full copy of the latest RP for each ECU within its domain, two full copies of the most recent two RPs for itself in the event of either a catastrophic corruption of its most recent RP or in the event of a power loss in the middle of a flash update, and a scratchpad large enough to hold the largest RP within its domain. For example, the scratchpad area may be used for the aggregation of a release package over a period of interrupted downloads. In some cases, only one incomplete RP may be allowed at a given point in time for aggregation. Thus, in order to initiate the update of another RP, the LVC-CS must first abandon the update of any current RP download. The LVC-CS may also provide a frontend engine implementing AUTOSAR UDS ECU programming protocol. This frontend engine may establish a link with the ECU to be updated and subsequently communicating with it, executing the update instructions for the particular EI and or RP.

Attention may be now drawn to FIG. 15, which illustrates a process flow diagram detailing a process 500 for transmitting an electronic image (EI) to a vehicle in accordance with at least one embodiment of the invention.

At stage 510, an EI for a particular vehicle may be identified at a server, and at stage 520, the server causes the transmission of the EI to the vehicle. The transmission of the EI may occur over one or more various communication pathways, including satellite, radio frequency, Internet, local area network or other technologies. Moreover, the EI may transmit through various components before reaching the vehicle. At stage 530, the vehicle determines if the full EI was received. If the transmission was incomplete, the vehicle causes the retransmission of the entire EI or the remaining portion of the EI at stage 540. If the transmission was complete, the vehicle updates equipment on the vehicle with the EI at stage 550. Finally, a confirmation of the update may be sent to the server at stage 560.

FIG. 16 illustrates a block diagram depicting system architecture in accordance with at least one embodiment of the invention.

FIG. 17 illustrates a block diagram depicting a system for transmission of an electronic image (EI) to a vehicle using a smart phone in accordance with at least one embodiment of the invention.

As noted herein, the VCCS ma maintain or connect to a database of ECU EIs. (Note—“image” or “images” may be used herein to refer to “EI” or “EIs”, respectively). The images may be grouped into three different groups.

The smallest group may be the set of EI objects found within a single ECU. An ECU usually has at least three (3) or four (4) images, with the minimalist list usually being: Boot-loader; Primary Application; Configuration Data; and One or more programmable logic device files. Additional images within a single ECU may be usually of some combination of the above listed four types of images and possibly for “other” processors within the same ECU (e.g., LCDs, Communication Peripherals, Compression or Encryption Processing Engines, etc.). For reference, FIG. 18 depicts an ECU release package Object containing up to n EI objects. In accordance with one aspect of the invention, objects in an EI database may contain the actual downloadable image. However, the ECU release package may contain instructions kept in UDS Script format precisely describing how each EI will be downloaded.

The next group may be the Vehicle Cluster release package (VC-RP), which may consist of all ECU release package Objects within a single Vehicle Cluster, where each ECU release package in turn identifies a specific set of EI Database record objects. For reference, FIG. 19 depicts a VC-RP. Each Vehicle Cluster release package object may identify ECU release package objects within the Vehicle Cluster on a per ECU basis. One or more modules (e.g., ECUs) within a single vehicle cluster may have the same image as “other” ECUs (where the shared image may be both within the same Vehicle Cluster as well as other vehicle clusters). However, care should be taken in how EI database objects may be shared between ECU release packages since two different ECUs may call for different versions of the same EI. In this case, two different EI database objects will necessarily be created and maintained.

The last group may be the Vehicle release package (V-RP) and may consist of the individual Vehicle Cluster release packages; each of which may identify a specific set of ECU release packages, which in turn identifies a specific set of EI database record objects. For reference, FIG. 20 depicts a V-RP. In accordance with some aspects, there may be only three different categories of Vehicle Clusters: Telematics & Infotainment; Body & Chassis; Engine Bay. However, additional categories are contemplated.

There may be a variety of options for implementing aspects of the systems and methods for remote updating of EIs at vehicles. FIG. 21, for example, depicts one implementation using an OEM cloud server and database architecture. As shown, certain of the inventive features of the invention may be reliably used as a software and hardware solution for OEMs to reduce interoperability issues across systems.

Attention is now turned to FIG. 22, which depicts several components within the vehicle, including: Vehicle Gateway Interface (VGI); Vehicle Cluster Connection Manager (VCCM); Vehicle Cluster Configuration Server (VC-CS) Database Manager; Telematics HMI Screen Manager; Flash File Manager; Universal Diagnostic Service (UDS) Frontend Engine; and UDS Port Interface Connection Manager (PICM).

The Vehicle Gateway Interface (VGI) may manage the data communication links between the Vehicle Cluster ECU and the Cloud Server. The VGI may be an abstraction layer for the Vehicle Cluster Connection Manager. As an abstraction layer, it may be highly dependent upon the operating system utilities and features available to it on the physical layer side of its interface. Specifically, it may need to interface to the GENIVI compliant, “Connection Manager”, as referenced within the GENIVI specification. Source code for the ConnMan implementation may be found at, http://connman.net/. The primary responsibility of the VGI may be to provide a data path between the Vehicle Cluster Connection Manager and one of the data ports for which it may be responsible via the aforementioned ConnMan GENIVI specified mechanism. The VGI may support the following connections: Wi-Fi; USB; Ethernet (for diagnostic connections); 3G/4G cellular connections; OnStar cellular connection; and be capable of monitoring and intercepting a SiriusXM satellite broadcast.

The Vehicle Cluster Connection Manager (VCCM) may manage the data path between the VCCS and the VGI. Primary duties of the VCCM may include: receiving notifications from the Cloud Connection Manager (CCM) when updates may be available; establishing connections with the Cloud Connection Manager (CCM) (assumes two-way communication on data-link, which may be the overwhelming nominal case); establishing receive end of broadcast connections when necessary and/or desired (e.g., notification to all owners of a particular make, model, and year that a specific update may be available); aggregating in a set aside RAM Disk and temporarily maintaining in flash storage when necessary; monitoring the progress of the update, including the number of bytes and report back to the Cloud Connection Manager the number of bytes aggregated in the event the link fails.; and notifying Vehicle Cluster Configuration Server upon completion and subsequent verification and decrypting of update download.

The Vehicle Cluster Configuration Server Database Manager may manage any/all of the databases. The databases may be built and maintained using SQLite, as mandated by GENIVI. More information on the SQLite software library may be found at, http://www.sqlite.org. The primary duties of the Vehicle Cluster Configuration Server Database Manager may include: maintaining and updating as needed the EI database, ECU-RP database, VC-RP database, and V-RP database; receiving and acknowledging notification from the OEM Cloud Server indirectly through VCCM whenever new updates may be available; receiving aggregated update once complete; distributing EIs from completed aggregated update; and notifying the VCCM that all updates have been completed and/or any issues preventing the updates.

The Telematics HMI Screen Manager may provide an HTML 5.0 GENIVI compliant interface to the databases within the Master ECU. Its primary purpose may be purely to report historical information, including status and error reporting. The Telematics HMI Screen interface may utilize the aforementioned GENIVI compliant “Connection Manager.”

The Flash File may manage the images which the boot-loader loads upon system reset. Additionally, the boot-loader code may be modified in accordance with the update methodology of the Update Framework. Specifically, this implies that there may be always two complete sets of images within the flash from which the boot-loader may load. The designated image set may be the image set designated as primary and indicated as such by a flag that can be read at system reset by the boot-loader. Typically, the location of the primary flag will be within an EEPROM or other persistent storage technology. The absolute offsets of the two images may be known at system compilation time so that only the selection of which image may be primary needs to be a volatile value saved in persistent storage. The Flash File Manager may designate the latest image set loaded as primary unless directed otherwise by a command from the VCCS or other source.

### Configuration Management Objects in Certain Embodiments

Configuration management objects may be those entities within, for example, the system of FIG. 1 that may be exchanged between the two ends of the system. The configuration management objects describe the transferred data and the organization of that transferred data. Configuration management objects may be divided into four categories: (1) DATA (e.g., EIs); (2) SCRIPTS (e.g., Programming Scripts); (3) LOGICAL GROUPING-I (e.g., VCCS Database Objects); (4) LOGICAL GROUPING-II (e.g., VCPS Database Objects).

The first category comprises the set of objects that may be being managed. The second category of objects control how the data objects identified in the first set will be treated. The third category of objects specify how to group objects identified in the first two categories of objects. Finally, the fourth category of objects may be the resultant aggregation of objects identified from the first two categories as organizationally specified by objects from the third category.

### First Category of Objects (e.g., EIs) in Certain Embodiments

ECUs included embedded devices designed explicitly for the automotive market and as with any embedded device, EIs (EIs) usually fall into one of four categories, including a ‘Firmware Image’ category (e.g., defined to be a complete standalone executable image that executes on specific processor within the ECU), a ‘Software Image’ category (e.g., defined to be an executable that integrates into an existing firmware image after the firmware image may be up and running), a ‘Data Image’ category (e.g., defined to be any set of data, configuration or otherwise, that may be used by some component within the ECU), and a ‘Programmable Logic Device Image’ category—(e.g., defined to be an executable image targeted for a specific type of FPGA, CPLD, XPLD, etc.)

Thus, any given EI can be thought of as the “payload” for remote update process. It, along with other related EIs may be the entities being delivered from the designated VCCS to a specific ECU of a vehicle. EIs may be grouped together at the most basic level for a specific release of an ECU. This means that whatever group of EIs that was used, tested, and verified to work together by the ECU manufacturer may be organized into a single entity called an ECU RP. In general, RPs may be organized according to physical and logical boundaries. Specified delineations for an RP, listed in increasing scope and complexity include: ECU RP (as mentioned above, this may be the most basic grouping of an RP); LVC RP; and Vehicle RP. As part of the RP process, the ECU manufacturer may certify that all of the EIs within the RP have gone through validation & verification (V&V) testing to ensure they work together and operate as both designed and expected. Validation requirements may be supplied by the OEM, and may comply with governmental regulations. The Verification requirements may be supplied by the ECU manufacturer (e.g., OEM or Tier 1).

### Second Category of Objects (e.g., Programming Scripts) in Certain Embodiments

The programming scripts maintained within the Vehicle Configuration Databases fall into one of four categories: EI Programming Scripts (e.g., AUTOSAR Compliant diagnostic ECU image update scripts, which may be paired with each EI and may be used to remotely control the target ECU for downloading); ECU Programming Scripts (e.g., Programming Script specifying the relative order in which: the EI Programming Scripts may be run; and other information that may be required to complete programming of the ECU and may be not or cannot be contained within any of the EI Programming Scripts); LVC Programming Scripts (e.g., Programming Script specifying the relative order in which the ECUs within an LVC may be programmed); and Vehicle Programming Scripts (e.g., Programming Script specifying the relative order in which the LVCs within a Vehicle may be programmed).

### Data Sources in Certain Embodiments

In accordance with certain embodiments, there may be four different categories of databases maintained within the systems described herein that have notable distinctions:

The first database category may consist of the data objects that the remaining databases may be all built upon and may be only maintained on the VCCS. Where the database must maintain an enormous amount of data, the database may be designed to minimize redundancies, and hence, the amount of storage required to maintain necessary the information. In this scenario, only the skeleton infrastructure of all of the various types of RPs may be maintained so that the database does not need to keep two copies of any given single object anywhere within its memory space. Actual RPs may be assembled in real time according to the identifying keys within each RP object.

Each subsequent database may be built upon objects from the immediate prior enumerated database (e.g., the ECU objects contain the EI objects). The VCCS databases, for example, may be relational databases with multiple keys, whose objects may be maintained in any manner desired. The VCPS may have only one database category whose objects may be strictly ordered in a linearly sequential manner as a means of simplifying the processing of them on their intended targets.

In order to adequately maintain an EI, additional information may be maintained at the database(s) beyond the EI. For example, primary fields found in any EI database object may include: [KEY] ECU Type Field (implies general category such as the Powertrain Control Module); [KEY] ECU Manufacturer Field; [KEY] ECU Model Field; [KEY] ECU Subcomponent Type Field (e.g., FEC, FPGA, CPLD, LCD, etc.); [KEY] ECU Subcomponent ID (8-bit numeric identifier); [KEY] ECU EI Release Version Number Field; [Data Content] ECI EI Certificate Number (Zero if no certification); [Data Content] EI Programming Script; [Data Content] EI; [Data Content] EI 32-Bit CRC; and [Data Content] EI DB Record 16-Bit CRC. Description of some of these fields may be provided below.

The EI Certificate Number may be a number obtained by a certification body providing confirmation that the EI went through a minimal degree of V&V testing. However, at this level, this could also be “self-certification” and does not necessarily requiring a formal validation from an independent body.

The EI Programming Script may be comprised of Executable AUTOSAR Compliant Unified Diagnostic Service (UDS) Instructions to be run by the LVC-CS ECU on an UDS Engine within the Image's Target ECU. Thus allowing the LVC CS Application performing the remote download and subsequent remote flashing to be designed in such a manner that it may be agnostic and unaware of any details specific to the image or the ECU it may be interfacing to. By including specific instructions for each ECU RP and each ECU EI, the entire interface and the Download Management Software may be both generic and extremely straightforward (e.g., the frontend of a download engine), thus, greatly simplifying the entire process and resulting resident code within whichever device contains the Download Management Software. The EI may be the actual Image itself (i.e. the thing that may be downloaded into the ECU).

The complete and formal aggregation of images found within a single ECU may be said to be within an ECU release package. By way of example, the primary fields found in any EI database object may include: [KEY] ECU Type Field (implies general category such as the Powertrain Control Module); [KEY] ECU Manufacturer Field; [KEY] ECU Model Field; [KEY] ECU RP Release Version Number Field; [Data Content] ECU RP Certificate Number (Zero if no certification) (e.g., certification on the ECU level implies cross-reference of all images contained within the specific ECU release package); [Data Content] ECU RP Programming Script; [Data Content] Number of ECU EIs; and [Data Content] ECU EI Array (e.g., each sub-record in this array may contain sufficient information to identify the precise EI record in the EI Database). The ECU EI Array may be arranged as follows: ECU Subcomponent Type Field (e.g., FEC, FPGA, CPLD, LCD, etc.); ECU Subcomponent ID (8-bit numeric identifier); ECU EI Release Version Number Field; and ECU EI DB Record Number. A ECU RP DB Record 16-bit CRC, which may only be valid when the ECU-RP Array within this record may be fully expanded (i.e., all of the ECU EI Data Content fields, including the EI image for each ECU EI record have been merged into the ECU-RI array). Certain fields may be described below.

The ECU RP Certificate Number may be a number obtained by a certification body providing confirmation that the EI went through a minimal degree of V&V testing. However, at this level, this could also be “self-certification” and does not necessarily requiring a formal validation from an independent body.

The ECU RP Programming Script may be an executable script specifying the relative order and other related information necessary for updating the ECU in the appropriate sequence. This script may act as a “master” script over the image specific UDS script found within each ECU EI Database Record object.

The Number of EIs may specify the number of Image release packages, where, ‘x’ represents the number of images.

When creating an ECU release package the ECU EI Database Record Number field may be replaced by the Data Content fields of the ECU EI DB Record, including the entire ECU EI. The only exception to this rule may be if the ECU EI DB record did not change between releases of the ECU release package versions, the ECU EI field will be all zeros.

The complete aggregation of ECU release packages within a single LVC may be said to be within an LVC RP. The primary fields found in any EI database object may include: [KEY] Vehicle Manufacturer Field (e.g., not necessary for the VCCS database, but may be necessary for the linearly sequenced release package that may be generated for the LVC-CS); [KEY] Vehicle Model Type Field; [KEY] Vehicle Compartment Type Field; [KEY] LVC-RP Release Version Number Field; [Data Content] LVC-RP Certificate Number (Zero if no certification) (e.g., certification on the Logical Vehicle Compartment Level (i.e., Engine Bay, Body & Chassis, Infotainment, and Telematics) implies cross-reference of all images contained within a specific LVC RP); [Data Content] LVC Programming Script; [Data Content] Number of ECU release packages; [Data Content] ECU RP Array (e.g., each sub-record in this array contains sufficient information to identify the precise ECU release package record in the ECU release package Database). The ECU RP Array may be arranged as follows: ECU Type Field (implies general category such as the Powertrain Control Module); ECU Manufacturer Field; ECU Model Field; ECU Release Version Number Field; and ECU RP DB Record Number (e.g., when creating a downloadable LVC release package, this field may be replaced by the Data Content fields of the ECU RP DB Record). The ECU RP DB Record 16-bit CRC may only valid when the fields specified in above have been expanded. The LVC RP DB Record 16-bit CRC may only valid when the ECU-RP Array within this record may be fully expanded (i.e., all of the ECU EI data content fields, including the EI image for each ECU EI record have been merged into the ECU-RP array). The ECU RP Programming Script may be an executable script specifying the relative order and other related information necessary for updating the ECUs in the appropriate sequence.

The complete aggregation of LVC RPs within a single vehicle may be defined comprise a Vehicle RP. Descriptive information within a Vehicle RP includes, but may be not limited to, the following information: [KEY] Vehicle Manufacturer Field; [KEY] Vehicle Model Type Field; [KEY] V-RP Release Version Number Field; [Data Content] V-RP Certificate Number (Zero if no certification) (e.g., certification on the Vehicle Level implies cross-reference of ALL images contained within a specific Vehicle release package); [Data Content] Vehicle Programming Script; [Data Content] LVC RP Array (e.g., the number of elements within the array may be no more than four; one for each different types of Logical Vehicle Compartments (i.e. Infotainment, Telematics, Engine Bay, Body & Chassis)). The LVC RP Array may include: [Descriptive Data] Vehicle Compartment Type Field; [Descriptive Data] LVC-RP Release Version Number Field; and LVC DB Record Number (e.g., when creating a downloadable Vehicle release package This field may be replaced by the Data Content fields of the LVC RP DB Record). The Vehicle RP DB Record 16-bit CRC may only valid when the LVC-RP Array within this record may be fully expanded (i.e., all of the ECU RP arrays for each LVC have been merged into the LVC-RP array). Some fields may be described below.

The Vehicle RP Programming Script may include an executable script specifying the relative order and other related information necessary for updating the LVCs in the appropriate sequence. The Logical Vehicle Compartment release package Array may include an array for the Number of LVCs (e.g., Engine Bay, Body & Chassis, Telematics, Infotainment) containing the relative offset from the beginning of the package of each ECU RP within the LVC RP.

Objects within a VCPS Database may be fully expanded RPs, regardless of whether or not the RPs may be abbreviated release packages or complete RPs. A fully expanded Complete RP may have all Data Content fields filled in with non-zero values; whereas a fully expanded Abbreviated RP may have zero values for Data Content fields of RPs that did not change between release versions of the encompassing object.

One of skill in the art will readily understand various features of the aspects described herein. For instance, various aspects provide for an end-to-end solution; a full configuration management of ECU releases; management of applications at both ends (e.g., VCCS and LVC-CS). One or more aspects provide for aggregation of EIs (EIs) in the form of release packages (RPs) at logically encompassing levels (e.g., ECU; LVC (i.e. Engine Bay, Body & Chassis, Telematics, and Infotainment); vehicle). One or more aspects provide for simplicity in that only a one-way data stream may be required for standard updates. One or more aspects provide for a complete and flexible system with an individual vehicle database maintained within the vehicle's LVC-CS ECU, or optionally maintained on OEM VCCS and/or a user-specified Vehicle Configuration Proxy Server. One or more aspects provide for further flexibility and simplicity in that a universal update mechanism may be used via AUTOSAR UDS for remote control and update of subordinate ECUs.

One or more aspects provide for multiple certification levels according to an aggregation level (i.e. ECU EI, ECU, LVC, and Vehicle level certifications). One or more aspects provide for efficiency where, regardless of aggregation level, release packages may be limited to only those images that actually changed. Thus, release packages with identical image releases across RP versions do not include identical images across subsequent release packages unless a complete RP may be explicitly requested. Therefore, download times may be reduced as compared to traditional update methodologies.

One or more aspects provide for additional safety because multiple levels of CRC checks ensure the RP and enclosed images may be downloaded intact, without any loss or corruption of data. One or more aspects provide for security by using end-to-end encrypted RPs (e.g., encrypted via AES Private Key encryption). Private Key may be known to all vehicles on a communication link, but may be updated on a frequent, periodic basis.

One or more aspects provide for both flexibility and reliability with an ability to regress or progress across multiple revisions (i.e., the inventive system and methods may be not restricted to one revision regression or progression). The only restriction to the number of revisions an update may go forward or backward may be directly dependent on whether or not data structure conversions may be required as part of the update. As most of the time data structure conversions may be only performed between two consecutive revisions and not across multiple revisions.

One or more aspects provide for a reliable Intelligent Download Aggregation Methodology where all downloads come in the form of release packages and where the release packages will aggregate over a series of download stops and starts. In this way, the LVC-CS remembers where it left off within the download process. One or more aspects provide for a reliable ability to recover corrupted images within a vehicle. Every master ECU may contain two complete release packages for itself and a complete copy of the most recent revision of the release package for each ECU within its domain. One or more aspects provide for flexibility where the system operates over a variety of physical data link combinations (e.g., SIRIUSXM Satellite, OnStar, Cellular 3G/4G, Wi-Fi, other networks, as well as derivations of each one). One or more aspects provide for flexibility where the various system components may be agnostic to the logical data transmission methodologies (e.g., HTTP 1.1, FTP, Red Bend vDirect Mobile Framework). One or more aspects provide for flexibility where there may be optional enforcement of certification levels above that of the ECU release package.

### Additional Aspects in Certain Embodiments

FIGS. 1-10 and 28A-B each illustrate different aspects of the disclosure, including system configurations and process flows. FIG. 23 illustrates an example process flow for executing a script associated with the Primary ECU. For example, the first Electronic Image may be specified within the Programming Script as the current EI for downloading. The main function of this Script is to update the Primary ECU hardware with the core/fundamental Electronic Images required for the Primary ECU to run with full functionality. The Scripting language used for the Primary ECU RP Update may be a UDS script, or some other scripting language. This may also simply be a function call as part of the core functionality of the software solution within the Primary ECU. If the default behavior for what occurs AFTER the Primary ECU has successfully completed, then the Primary ECU will do a “Reset” as a “sanity check” to ensure the latest revision is viable prior to updating “other” subordinate ECU's. Otherwise, in the event of a failure of the latest revision to properly run upon system reset, the subordinate ECUs would then also need to be “restored” to their prior state as well. It is not so much a “safety check” as it is a potential time saver. The default behavior should be enabled if the Primary ECU is the VERY first ECU within the VSD RP Script.

FIG. 24 illustrates a low-level function call for writing to the area of non-volatile storage where the Electronic Images are kept (i.e. usually near the beginning of the non-volatile storage medium within a static offset and NOT part of a dynamic file system).

FIG. 25 illustrates a process flow for executing a Unified Diagnostic Service Script associated with the subordinate external ECU. The First Electronic Image may be specified within the UDS programming script as the current EI for downloading. The main function of this UDS script is to update the subordinate external ECU hardware with the core/fundamental Electronic Images required for the subordinate external ECU to run with full functionality.

FIG. 26 illustrates a low-level function call for writing to the area of non-volatile storage where the Electronic Images are kept (i.e. usually near the beginning of the non-volatile storage medium within a static offset and NOT part of a dynamic file system).

FIG. 27 illustrates a process flow for executing a UDS script to program the targeted ECU. This script accesses the downloaded Electronic Images and then transmits it to the target device (external ECU), which in turn the target device (i.e. targeted external ECU) saves it into its (the targeted external ECU's) memory. Unlike the Electronic Images of the Primary ECU, these Electronic Images may be maintained within the dynamic file system of the Primary ECU and used by the Primary ECU application image.

One aspect relates to vehicle accident or other event reporting. In accordance with this aspect, measurements may be taken of critical components within a vehicle, stored, and transferred. For example, a telematics/information vehicle subdomain may automatically notify authorities of a potential accident or catastrophic event. Various environmental inputs are contemplated, including deployment of airbag; sudden loss of air pressure in a tire; internal gyroscope detecting a hazardous angle or transition of car from one orientation to another; sudden loss of power to key components, while other components remain operational; and other inputs. Weights may be applied to the environmental inputs, and a notification may be issued when an overall weight exceeds a threshold level.

One aspect relates to a methodology that accesses the downloaded Electronic Images and then transmits it to the target device (external ECU), where the target device (i.e., targeted external ECU) saves it into its memory. The methodology, which is similar to the process flow shown in FIG. 27, performs the following first stage of steps: Connect to the Diagnostic Port of the Target Device., and determine if the download is a continuation of a prior partial download (i.e., is DownloadInProgressReleasePackageRelativeOffset>0; NOTE: This check may apply for the case in which the unit powered down prior it being able to do this check after an increment). If the download is not a continuation, set Base Address to write to in External ECU to that of the Alternate release package. (i.e., DownloadReleasePackageBaseOffset=ReleasePackageAbsoluteBaseOffset [AlternateReleasePackage]), and then proceed to the second stage of steps. Otherwise, if the download is a continuation, determine if the byte is the last byte of the release package (i.e., is DownloadReleasePackageRelativeOffset>=SizeInBytesOfNewReleasePackage). If not, go to the second stage of steps. If so, then go to an end stage of steps.

At the second stage of steps, a next byte is sent to be downloaded into a targeted external ECU (i.e., SuccessfulWrite=WriteByteIntoExternalNV_Storage (NewReleasePackage, DownloadReleasePackageBaseOffset, DownloadReleasePackageRelativeOffset)). A determination is made as to whether the write was successful (i.e., is SuccessfulWrite>0). If not, a call is made to ERROR_HANDLER to quantify the error if possible, pause the update, report error state, save off variables, and exit. If it was successful, a byte offset value is incremented (e.g., DownloadReleasePackageRelativeOffset++), and it is determined whether the byte was the last byte of the release package (i.e., DownloadReleasePackageRelativeOffset>=SizeInBytesOfNewReleasePackage). If not, the second stage of steps is repeated and the next byte is sent to be downloaded. Otherwise, if so, the methodology moves on to the end stage of steps. At the end stage of steps, release package settings are changed (i.e., AlternateReleasePackage=CurrentReleasePackage; CurrentReleasePackage=˜CurrentReleasePackage & 0xFE). NOTE: This may assumes no synchronized (i.e., timed) release package instantiation in this algorithm. A Relative Address may then be cleared so that the algorithm knows it is a “new” release package the next time it enters this function (i.e., DownloadReleasePackageRelativeOffset=0). Then the process ends.

One other aspect relate to a Proxy Server that determines the correct update for a particular car (or group of cars), and then communicates that update to the car(s) while the cars may communicate which byte is needed. For example, when a car pulls up, the server detects the car via some wireless communication exchange of information, the server determines what to deliver based on what the car specifies it needs, and the server determines where to start delivering (e.g., based on information sent from the car to the server). Multiple proxy servers may be geographically distinct, and independent of each other. Another aspect relates to pausing and resuming downloads of updates to vehicles from servers.

Additional aspects relate to recovery of corrupted images: (1) steps to identify corruption; (2) steps to recover and determine if image is missing key feature (e.g., using correlation techniques) or if execution of image is not providing recognized result. One “unique” feature about this approach is a built-in system wide recovery mechanism with respect to corrupted images. The system may autonomously execute a self-recovery strategy, enabling it to re-instantiated itself into a consistent, known state, regardless of all but the most pervasive of corruptions.

Another aspect relates to an autonomous nature of recovery and self-management within the system (e.g., vehicle with system components). A master ECU may self-manage in a way to store and deliver updates to itself and other ECUs along with recovering from corruptions when/if needed. The ECU also does this in an intelligent manner monitors which elements of the system go with which ECU and cross checks not only EIs within each individual ECU, but also within the vehicle subdomain to which it belongs and the vehicle domain as a whole.

Other aspects may include: Embedding controlling functionality (i.e., the device controlling the unit being updated) directly within the vehicle and specifically within another ECU (e.g., a Telematics Control Unit or Head Unit); including a “network” of “Master ECUs,” each controlling their subnetwork of ECUs, with the TCU/EU being the controlling “Master” device (i.e., the Master of Masters if you will); dividing the content/configuration management system into internal vehicle subdomains; A vehicle itself potentially acting as a “Proxy Server” to other like vehicles in an M2M fashion; An agnostic nature of the approach with respect to either OEM or ECU (e.g., agnostic with respect to the hardware having a ubiquitous internal vehicle update solution that is neither directly dependent upon operating system nor ECU hardware); a Configuration Management infrastructure, including the types of fields necessary to organize (e.g., particularly with respect to anticipating V&V type of information as part of the rule based decisions for organizing the release packages); The ability for the vehicle to completely revert an entire vehicle release in the event of a catastrophic error to the previous version; Having database and distribution system within vehicle for self-recover; Take control and distribute within vehicle with disrupting simultaneous vehicle operation; and Partial download (to vehicle) and partial update/install (to internal location—monitor at distribution port to push when ready, monitor at receiver port to pull when available).

In accordance with one embodiment, the basic steps from the “inception” of a new Electronic Image to actual “deployment” of the new EI (and “other” required ancillary files and information) may be as follows: Tier 1 ECU Manufacturer updates one or more Electronic Images (EIs); Tier 1 ECU Manufacturer creates a new ECU release package (RP) based upon the updated EI(s); It is “assumed” that either the Tier 1 ECU Manufacturer collaborated with a third party test facility or did so themselves to verify that the new EIs did not degrade the interoperability functionality between itself and the other ECUs within a Vehicle Subdomain (recall, there are five classifications within the model of Vehicle Subdomains: (1) Powertrain; (2) Chassis; (3) Telematics & Infotainment; (4) Body Electronics & Cabin Comfort; and (5) Safety and Security); As a result of the above steps, in addition to the ECU release package (RP) created above, a Vehicle Subdomain release package will also be created by whoever is responsible for coordinating the interoperability functionality (If nothing else requires changing, this may be as simplistic as making a copy of the prior Vehicle Subdomain release package and substituting the NEW ECU release package in the place of the prior ECU release package in the most recent Vehicle Subdomain release package); Once there are “multiple” Vehicle Subdomains implemented, a new Vehicle Domain release package will also be required as a result of the updated EIs; All information listed in previous steps may be conveyed to the OEMs Configuration Database server; The OEM notifies the Backend Server of the updated EIs, RPs, and other associated information; The Backend Server processes/converts the updated EIs, release packages, and other associated information into the required format for downloading, processing, and distribution by the In-Vehicle Server (Part of the processing/conversion of the data sent to the Backend Server by the OEM Configuration Database Server will be to add additional information the In-Vehicle Backend Server & Distribution System it requires to complete its tasks. This may or may not require the Backend Server soliciting additional information from the OEM Configuration Database Server not originally sent to it.); The Backend Server will update its own internal cross reference list of Make/Model/Sub-model/Year and release package versions (This Cross Reference List is used in periodic broadcast/multi-cast transmissions at TBD intervals; notifying all delineable vehicle categories within its database of the most recently available update for each category; where a delineable vehicle category is defined to be, Make/Model/Sub-model/and Year.); The Backend Server will transmit out a “broadcast” or (preferred) a multicast notifying all affected vehicles that an updated set of releases is available to it; The Web-Services Client (WSC) interface receives both the Update Broadcast/Multicast from Backend Server as well as the periodic broadcasts/multicasts confirming most recent release information. It then conveys that information to the In-Vehicle Server for consideration; The In-Vehicle Server then determines if has the most up-to-date release packages (If so, nothing further needs to be done. If not, it then, according to its internal and personalized policy based configuration, decides whether or not to solicit the updates from the Backend Server.); If the In-Vehicle Server determines not to solicit the updates, then no further action is required.; In-Vehicle Server determines that it desires to be updated, then it solicits through the Vehicle's Web-Services Client interface to the Backend Server for a session to begin specific to that particular vehicle; The In-Vehicle Server will initiate and continue attempting to contact the Backend Server until a valid session has been established and successfully completed, regardless of the number of attempts it might take; Once the In-Vehicle Server has established a virtual connection to the Backend Server, the Web-Services Client begins aggregating a download of only the actual EIs and other files within the updated release packages that are “different” from the files of the release package currently within the In-Vehicle Server.

The In-Vehicle Server's most recent release package may not be the same as the release package immediately prior to the release package being downloaded. Thus, the In-Vehicle Server may alert the Backend Server as to precisely which release it is currently using so that the Backend Server knows which files to send down. In truth, the Backend Server should already know exactly what the latest release package(s) the In-Vehicle Server is maintain, however, it may confirm this with the In-Vehicle Server rather than risk making an invalid assumption which could lead to catastrophic consequences if an incomplete release package was allowed to be distributed throughout the vehicle.

Once the files have been isolated that are different between the two release packages (i.e., the one to be downloaded and the most recent release package currently on the server; which may or may not be the active release package), a differential algorithm is utilized (i.e., Google's open-source Cougarette algorithm) to compute ONLY the differences between the affected files. Thus, ONLY the differentials are downloaded; saving both time and bandwidth.

Additional steps may include: The Web-Services Client aggregates the download until which time one of two events occurs (E.g., either the download completes or the download is interrupted for any one of a number of reasons including system power-down. In either case, the Web-Services Client remembers where the download stopped since the download was aggregating within a NV storage scratchpad and is capable of resuming the download precisely at the cessation point once the system is active again and the virtual connection reestablished.); Once the download has successfully completed, the aggregated differentials are first decrypted if necessary (i.e., if encryption was used) and then subsequently combined with their predecessors to formulate the new updated Electronic Images, Scripts, and other related differential files representing various elements detailed by a release package. The processed differentials and prior RP files are then validated against CRC, Checksum, and other integrity checks to ensure the new release packages and associated files are valid. If the downloaded files fail any check, the entire process is repeated. Otherwise, the Web-Services Client notifies the In-Vehicle Server that a new RP (or set of RPs) is (are) ready for downloading; If the downloaded files pass all checks, then the In-Vehicle Server will begin processing the release package(s) for distribution to the appropriate (targeted) ECUs; There are three methodologies that can be utilized for the distribution phase of the EI Download & Distribution process. The chosen methodology is directly dependent upon “Policy Decisions” made by the OEM regarding how much memory it is willing to pay for within an ECU.

In some cases, the primary ECU application does not execute from the same area of non-volatile storage from whence it is stored. If this is not the case, than the ECU may be placed in an quiescent state (non-operative) that allows the boot-loader and diagnostic stack to operate and process Diagnostic Commands (particularly those related to the download/update process). The Diagnostic Stack can operate whilst the primary application is also in operation. This implies that the Diagnostic Stack has been integrated into the primary application or if the subordinate ECU employs a Virtualization Software Architecture, then the Diagnostic Stack may run as a separate VM within the subordinate ECU.

### Updating Electronic Images in Certain Embodiments

The following section may be describes one or more implementations of a process for updating vehicles or other electronic devices. Systems may use may be a collection of packages, where a package is an abstract representation of data that is relevant to the system (this can be a package providing some files or libraries in base system, firmware file, image of flash memory for devices accessible from the system). Each package in the system is versioned, however, the method of versioning is outside of the scope of this document. It's required that the employed versioning scheme allows for determining which version of package is newer.

Systems described herein may handle both Firmware Over the Air (FOTA) and Software Over The Air (SOTA) change sets. From the perspective of the update process, FOTA and SOTA are distinct sets of packages, with possible dependencies between elements of both sets. Assumptions for handling of both SOTA and FOTA are the following: head unit firmware contains a snapshot of head unit's software; a dependency between software and firmware may exist, such that a software package may require a particular version of firmware to be present in one of the components; the platform provides means of firmware rollback and recovery if needed for FOTA.

### Release Package

At any given point of product's lifecycle, the snapshot of all the packages and their versions that the system consists of is called a release package (RP). A release package can be versioned, where an RP of subsequent version number may update, downgrade, add or remove packages from the system. The release package of any given version may be considered a virtual snapshot of the system, as the list of packages it consists of can be determined by taking the base version as reference and applying all subsequent RP changes on top. It is possible to skip intermediate release packages and update directly from one version to another, provided the packages that are part of the upgrade can handle any required changes to the data or resources that they use. It should be possible to designate any RP a base version, so that it can be used as reference for subsequent updates, hence shortening the amount of analysis required for the update process and allowing for introduction of freeze points.

As shown in FIG. 29, each RP version is a virtual snapshot of the packages that the system consists of. Packages that are actually delivered in the particular RP release, are considered to be defined in that release. Packages that are not delivered in given RP version, are implicitly defined based on previous RP version installed in the system.

At any point, if the device has a particular RP version installed, then all the packages, both explicitly or implicitly defined are present in the system in versions that correspond to that RP. is responsible for performing update operations in such fashion that the condition is met. A logical representation of RP, based on domains the respective packages fit in is shown in 30. Every RP version can be presented in form of such tree. As seen FIG. 30, some nodes may not need package files. For other nodes, the package files are essential, with rules of package being either explicitly or implicitly defined within RP being exactly the same as in FIG. 29. Note that the elements of RP may either be software packages or firmware binaries. The concept is illustrated in FIG. 31. As show in FIG. 31 one of the elements of firmware tree is the Head Unit firmware file. Head Unit firmware is also considered to be a snapshot of the associated software RP. It is expected that there is a dependency between the software packages and firmware packages, such that certain software elements may require particular firmware versions for correct operation. In order to determine a complete version information of the system, FW RP and SW RP need to be used in conjunction. Thus the changes over time to both FW RP and SW RP can be presented as in FIG. 32

### Freeze Points

Freeze points are an optional addition to the versioning process of RPs. They can be considered a pivot point, where the vendor may decide to break backward compatibility. Let's assume that currently we have in the system versions of RPs from N to N+4. Without the freeze point upgrade process can look like in FIG. 33. There is no limitation about the ways of upgrading. So the system can be upgraded from version N to N+4 directly or it can be upgraded version by version. The problem here is that RP provider has to create RPs that allow upgrading from arbitrary version. In case of many versions in the system, providing such functionality might become a significant burden. The freeze point is a mandatory step in the update sequence. Any subsequent updates need to handle the versions starting from the freeze point up.

FIG. 34 presents an example scenario of updates with freeze points. In an extreme case it is possible to deem all RPs as freeze points.

### Update Package Set

Whenever an update is made available, the system must determine the current RP and the target RP. The list of packages to be changed can be obtained by comparing the snapshot for current RP and target RP, taking into consideration that packages may be added, removed or updated. In order to handle a case in which a device has skipped an update, the virtual snapshots for current and target RPs should be compared. An example of an update set is shown in FIG. 35 A device is at RP 1 and updating to RP 3. By comparison of virtual snapshots, 3 packages are found to need an update. The analysis should be performed on the update server, rather than on the device.

### Update Installation

General concept of the update process installation is shown in FIG. 36. The operator makes a new RP available on the backend server. Once an administrator process identifies that a new RP is available, the required files get downloaded (all files are downloaded to the Head Unit local storage). The Update Manager (UM) process then applies the updates using the most appropriate methods for each package as indicated by the operator.

As systems described herein supports a number of environments of differing package formats and update methods, the adaptation layer in form of plugins is provided at the level of Update Manager process that helps to hide the differences. It is assumed that for a given RP update, the whole update process is considered a transaction, hence all packages must be successfully updated or the update fails and is rolled back. Similarly, the update of a single package is considered a package-wide transaction, and all the steps shown in FIG. 37 need to be successful. The rollback scenario may be executed if update process failed, or can be triggered on demand. It is assumed that rollback to last known configuration can be possible even with limited connectivity. The reason for this assumption is that the update might have introduced a change that caused connectivity loss.

Update Manager has no knowledge of the required modifications to the data or resources used by respective packages, neither of the actual operations that need to be executed to ensure the proper level of update integrity. CS UM provides means and tools for preparation and delivery of the update files, as well as drives the update process by enforcing correct update states sequence. A vendor may be responsible for providing the update that can be successfully applied, with the relevant applications remaining stable and operational. Steps such as data format changes, restating of relevant processes, as well as rollback support need to be properly provided in the scripts that are run within the scope of given package format. Update Manager provides means of logging, so that each step is logged, allowing for the update process to be traced, or even span across device reboots. Similarly, means for error reporting are provided. Whenever a package update fails, the problem will be logged, and an indication will be provided in a suitable format that will be agreed on later.

### Implementation Details

Each update will be delivered in form of a RP, consisting of Update Files (UF). An Update File is an abstract name of a file that has to be delivered to a device. FIG. 39 illustrates a logical view of a RP with single or multiple UFs. For purpose of implementation, UF will be defined by a UF descriptor (carrying relevant metadata) and the files that are part of UF. Similarly, RP will be described using a RP descriptor (metadata), which can be a single file and a set of UFs. More detailed example of RP is shown in FIG. 40. The device attempting an update does the following: Download RP descriptor; Parse RP descriptor for a list of UFs; Download respective UFs; Parse UFs metadata; Download the content of UF; Apply updates.

### Release Package (RP)

A release package is a virtual container that includes one or more UFs in one update. Every RP has a set of properties that include information such as version, range of VINs etc. It should be possible to serialize RP descriptor into a human readable format, such as JSON or XML. For purpose of this document, JSON is assumed as the preferred method of serialization. The UF is defined by UUID, version number and the URL for downloading a particular version of UF.

TABLE 1
Release package properties

| Property | Type | Description |
|---|---|---|
| FW Version | “major.minor.build” | Version of firmware RP |
| SW Version | “major.minor.build” | Version of software RP |
| Vehicle States | Set of strings | Set of vehicle states that are allowed to start the vehicle |
| | | update process. For example: |
| | | [“engine off”, “car stop”] |
| VINs | List of VINs | Set of VIN numbers for which particular RP is |
| | | designed. If particular vehicle (VIN) is not in the set, |
| | | that RP should be skipped. The set can contain VIN |
| | | numbers as well as the mask/patterns in a given format |
| | | (TBD, below examples): |
| | | **************** |
| | | 3123*RTS***3246 |
| | | [0-5]ASR******ASDFGT |
| | | [0-5]A[C-F]R******ASDFGT |
| FW-UF list | Set of UF | FOTA List of UF in particular RP. |
| | | TBD: UF will be provided as the names of files or some |
| | | UUIDS or some combination of UUID and version |
| | | number. This will be clarified later. |
| SW-UF list | Set of UF | SOTA List of UFs in particular RP for updating Head |
| | | unit |

### Update File (UF)

Update File is a descriptor for a file delivered as part of the update. Due to a wide range of possible applications, UF may refer to different types of data files. The archive may be compressed using one of the well know compression methods, gzip, bzip2, LZMA. Logically, the update file can be presented as in FIG. 41. Note that the actual data file is not delivered as part of UF, it is downloaded separately, possibly even from a different remote location.

TABLE 2
Update File properties

| Property | Type | Description |
|---|---|---|
| Version | “major.minor.build” | Version of RP |
| UUID | UUID | The UUID of particular component in the system for |
| | | which this UF is designed. UUIDs are managed by |
| | | systems disclosed herein. |
| DataFile | url | The file/data that contains proper data for particular |
| | | update. It can be the raw data, zipped, rpm, deb, etc. It |
| | | depends on FileType property. |
| DataType | from defined set | This is a type of BinaryFile. Currently allowed types |
| | | are defined as: generic (for purpose of PoC); package; |
| | | package delta; . . . TBD |
| Checksum | object | Object that describes typed and data. |
| RebootFlag | boolean | This flag indicates if reset of headunit should be |
| | | proceed after update or not. Resets of particular |
| | | components/ECU will be described in hooks scripts. |

The UF may carry a set of scripts that, depending on DataType, are used during different stages of the package update process.

TABLE 3
Update File scripts

| Script | Purpose |
|---|---|
| check | Verification of data file; verification of system state and |
| | dependencies |
| pre | Run before performing update; Stop/start services, prepare |
| | environment, filesystems |
| update | Perform update; carry out relevant steps that lead to data file |
| | being applied in system |
| Post | Run just after update step is finished; start stopped services; |
| | cleanup temporary files |
| rollback | Run during uninstallation; remove package from system |
| recover | Run in case any of the update steps fails |

In case of SW release package, an Update File may not only update a package, but also add or remove one. An example scenario in which a package is being removed is the need to drop the functionality provided by given package as it is being replaced by another one that may be in conflict. In scenario of package removal, the UF triggering the action will have a subsequent version number, but the update script should perform all operations needed for erasing a package.

### Update Plugins.

This section documents all package type plugins supported by Update Manager. Update Manager does not have the means of interpreting the actual data file associated with UF. The functionality required for applying an update is delivered in the form of update plugins. Each UF has an associated DataType property that indicates what plugin can be used for applying the update. Whenever a new type of data file is added to the system, corresponding update plugin has to be present as well.

TABLE 4
Update plugins

| Plugin/data type | Description |
|---|---|
| Generic | Generic update plugin, the required |
| | functionality is provided in form of user |
| | supplied scripts found in respective UF |
| | packages. |
| Package | OS platform specific package format |
| package delta | OS platform specific delta package format |

‘Generic’ plugin. The generic plugin can call user supplied scripts that are contained within UF archive. The scripts provide the actual functionality that is needed for performing the update. The scripts are assumed to require bash interpreter. Each script can return 0 as its exit status to indicate success, or any other value to indicate failure.

A process corresponding to how scripts are called during the update is shown in FIG. 42.

‘Package’ plugin. Package plugin uses the underlying OS API for interacting with local package management system. In case of Tizen OS, the plugin interacts with RPM database. The plugin refers to the API exposed by respective libraries to carry out the update steps. The plugin can run relevant RPM hooks provided in the package.

‘Package delta’ plugin. Depending on the mechanisms available in the package management system of the underlying OS, the Update Manager may support package delta plugin. The purpose of this plugin is to apply a diff on the package, by performing operations on both the OS package database and the package files. In case of RPM (Red Hat Package Manager), the plugin will use delta RPM files. Using delta RPM, the amount of downloaded data is limited, at the expense of increased processing time when applying an update. The delta RPM packages require the actual RPM package to be rebuilt locally, by reconstructing the original package and applying delta on top. After the rebuild step is complete, additional checks are performed to verify the package integrity. The plugin can run relevant RPM hooks provided in the package.

### Vehicle State Interaction

Interaction with vehicle state needs to be considered. It is possible that the update process will only be allowed provided certain global conditions are met. An entity called Vehicle State Manager (VSM) has been introduced in order to hide_the logic of vehicle state control. The proposed interaction mechanism with VSM is shown in FIG. 44 and FIG. 45.

### FOTA and SOTA

FW and SW RPs are versioned separately, but they do interact with each other, hence dependencies between the two need to be considered. A SW release package described the state of the software components that make up certain release. Given this, the FW release package of a component that is versioned with SW RPs as well (head unit is an example of such component) has to be considered as a frozen snapshot of the SW RP. In the example, both SW RP and FW RP is modified. Worth noting is the fact that the Head Unit's firmware remains at version 1, but SW RP reaches version 7 at some point. However, once a vehicle has undergone maintenance, the firmware of Head Unit was updated to version 2, which only contains the SW snapshot corresponding to SW RP 3. Effectively a downgrade of SW RP was performed.

### Universally Unique ID of Update Files

In some embodiments, every Update File has a UUID assigned. Depending on the RP tree under consideration, the UUIDs of UF for FW and SW data sets follow the same concept, but have different origins. An Update File for FW release package, has its UUID equal to one of the component that it is assigned to, for instance, for a component of UUID. Hence, the FW Update File uniquely identifies the target component. For SW release packages, the UUID of UF corresponds to an ID assigned to particular software package that is used within the OS. For example, a package known in the OS as xorg-server may have a UUID 4c6d84a0-2285-4653-0003-000000000001. Then, all Update Files for xorg-server package will have the same UUID, but differing versions and pointing to different data files. The UUIDs for software packages can be assigned by backend server, once the package has been added to the repository.

### Head Unit Architecture

Functionality delivered by may impose certain requirements on the underlying hardware or software. Bootloader requirements. The following functionality must be exposed by the bootloader: means of reading the currently running software version; means of changing the software version to be run after reboot; and means of reading whether an error has occurred when booting the firmware. Partitioning and storage requirements. Update Manager must keep track of replaced versions of firmware and software packages for the use in offline rollback scenario. This requirement implies that considerable storage may be required. For the purpose of Head unit FW update, it is required to have a least 2 partitions for keeping HU firmware. The bootloader can be able to boot either partition as instructed.

Interaction between Administrator and Update Manager. It can be noted that the element interacting with Backend Server is the Administrator process. However, the RP can be fully understood by the Update Manager process. For this reason, once a new RP has been received from the server, both components interact as shown in FIG. 47. The RP may optionally contain a list of states that the update is allowed to take place in. Only if the state is in the set of allowed states, can the update proceed.

### System Architecture and Other Aspects in Certain Embodiments

The following section describes system architecture aspects relating to a Vehicular Configuration Management, Remote Firmware/Software Update, & Delivery Framework. The Vehicular Configuration Management, Remote Firmware & Software Update, and Delivery Framework is agnostic to the physical medium data pipe; it is also agnostic to the logical methodology used to transport data so long as the inward facing ports have been implemented within the transportation model (i.e. allowing download sessions to pause and resume across a series of multiple connections). As a consequence of the “one to many” relationship between the “server” and the “vehicles” it serves, the data link may include many data links. Thus, as a practical matter, a distributive architecture is used for both implementation of the database as well as the communication links between the Backend and the individual vehicles it serves. FIG. 48 illustrates this point. Refining this requirement (for a distributive architecture) even further, FIG. 49 details one implementation.

The architecture continues with three layers, but the data link is implicit within the M-Queues (utilizing RabbitMQ as the actual M-Queue implementation): Backend layer/Web UI responsible for communication with the Tier 1/OEM as well as to present data and reports to them; Cloud layer provides functionality for both file & database storage that utilizes distributive technologies for messaging (with the specific implementation being RabbitMQ M-Queues) and Database (with the specific implementation being the distributive NoSQL database Riak open source solution); and Vehicle includes the In-Vehicle Server & Delivery System resident within every vehicle. Detailed information about different components is described in Table 5.

TABLE 5
System Components

| Component | Description |
|---|---|
| WEB UI | Portal which will be used by Tier1/OEM to provide proper configurations |
| | and data to system as well as to presents to them statistics and other |
| | information; depending upon where the actual Data Center resides. |
| Backend | Infrastructure remote from vehicles (usually including processors, memory |
| | with instructions, and data sources) |
| RIAK DB | HTTP + JSON interface is exported. |
| RabbitMQ | Message broker - it which will be responsible for handling special queues |
| | which will be used in data exchanging between vehicles and low-level |
| | backend. |
| Apache + | In case of need any kind of authorization this component will have to |
| GlusterFS | communicate with Low-level Backend. |
| Vehicle | Vehicle with solution. |

FIG. 50 shows elements of the architecture that are scalable and deployed as a cluster/cloud. FIG. 51 shows a general architecture of the Backend. There are three main internal components (as listed below): Crypto subsystem, which is responsible for all cryptography operations (like AES encryption, key generation etc.); Local file storage, which is responsible for keeping files (upgrades) provide by user (OEM/Tier 1) in clean format; this storage should not be expose to external network; and Local DB, which is a local database which is using for local purposes (as logins storage, etc.).

### Data Encryption of Upgrades

Systems disclosed herein provide possibility of encrypting upgrades by using symmetric algorithm—AES. There will be supported at least two AES methods: CBC (Cipher Block chaining), and CTR (Counter mode). There will be possible to use the three lengths of AES key: 128, 192 and 256 bits. Diagram below illustrates the main architecture of cryptography subsystem responsible for protecting files. The main component that is responsible for encrypting data is located on Backend server. This component is responsible for creating AES key, encrypting data and sending outputs (key, encrypted data and meta data) to proper places (local database, RIAK database, Gluster FS). FIG. 52 depicts an encryption architecture. In some embodiments, every AES key is recognized by UUID which is created and associated to it during creation phase. This special UUID is stored in RIAK database (and it could be also stored in local database) together with the key value. So to encrypted data this UUID is also assigned, but one key (UUID) can be used for multiple files (one key can be used to encrypted several files). FIG. 53 and FIG. 54 illustrate aspects related to encryption.

The AES key should be stored only in the secure places. The whole backend will be designed and deployed in such way that they will be secure. In case of vehicle everything depends on the current Tier 1/OEM solution. The AES key should be also delivered to the vehicle by using secure channel. To connect vehicles and backend system there will be used RabbitMQ message broker which will be configured to use SSL connection. Refer also to “JSON Messages” chapter which describes the messages that are exchanged between backend and vehicles to get some knowledge about possibility of retrieving AES information.

For testing purpose there may be a special Test Server and Test daemon which can be started on a vehicle. FIG. 55 illustrates aspects related to a test server. The Test Server will be responsible for remotely invoking test scenarios as well as collecting results. Test Server will also communicating with Backend and RIAK DB to provide data that is required by test scenarios. Test daemon will run on vehicle, it will communicate (via DBus interface) with other components which are run in vehicle. The Daemon also communicates with the server in order to execute the precise tests and also for returning the test's results.

Vehicles may use RabbitMQ to exchange data with Cloud Server. RabbitMQ is message broker software that implements the AMQP which can be scalable. Communication has to provide three possibilities of exchanging data: Sending reports and statistics by vehicle to BE; Requesting some data by vehicles; and Broadcasting messages to particular or all vehicles by BE. Table 6 and FIG. 56-57 illustrates an architecture for data exchanging in various solutions.

TABLE 6
Data Communication Components
Description

Queue: In the architecture there can be queues with well-known name:
REPORT (for receiving reports from vehicles),
RPC (for handling request from vehicles), Or queues that are dynamically create for particular
vehicle needs: gen-X1. . . , gen-N1 . . . , etc. Please note that names for dynamic queues are create
automatically by RabbitMQ and names used in this documentation are used only for illustration
the idea. There are two types of dynamic queues:
Request's responses (gen-X . . . ),
Notifications (gen-N . . . ).
Exchange: Exchange “X” is used to distributed messages from producer to connected queues.
In there will be one exchange named NOTIFICATIONS.
Server node: The Server node “S” provides functionality within the Low-level Backend that is
responsible for handling requests and notifications from vehicles as well as initiating notification
to vehicles.
Client: Vehicle Component “C#”.

For reporting any kind of data within the vehicle, the REPORT queue is used. Vehicles send data to this queue which than is processed by a special handler on the server side. Requesting any kind of data (or in general invoking any kind of functionality on the server sided) from within vehicle is more complex. It may require: a queue RPC, to which all vehicles can send requests; Server Side Handler that is responsible for processing particular request and then send the response (result) to the queue (which name is provided by vehicle during issuing a request); and Helper queue which will be used for retrieving responses. FIG. 57 illustrates this scenario.

Notifications in solution are done by using Exchange and Dynamic queues linked to this exchange. Diagram below illustrates it. There is also possibility to create special “filter” which will be used to deliver particular notifications to vehicles which fulfill the filter's mask. FIG. 59 illustrates which side is responsible for creating particular elements of an exchanging subsystem. All of these elements are created on RabbitMQ server.

### General Vehicle Architecture

The General Vehicle Architecture, may operate in a vehicle, is depicted in FIG. 60. The architecture addresses 5 components: Controller; CarInfo; Downloader (which will be substituted by GENIVI DUMM component in the future); RepoUpdate; USB Drive Monitor; UI (optional). A brief description regarding every component can be found in the ensuing sections. Various components are independent processes that communicate with each other via DBus.

### Controller Component

The Controller component is the main component within System™ vehicle framework. It is responsible for controlling the entirety of the System™ components on the vehicle side. His component is also responsible for: Exchanging messages (in JSON format) with the System™ Cloud Server and then processing them (via RabbitMQ); Controlling other components (e.g., Requesting a file to be downloaded; Starting the update process; Displaying information via the UI component to the user); and Handling error cases.

The ensuing diagrams show interaction between the Controller component and other components.

### CarInfo Component

This component is primarily responsible for: providing information related to vehicle's status and some another information (i.e. VIN number, network interfaces etc.); these data can be retrieved by using CAN Bus; handling internal database in which all information related to H/W configuration (ECUs list) will be stored; such database will be located in non-volatile memory; handling internal database which will be used to storing history information about updates, etc.

Download (i.e. GENIVI DUMM) Component

This component is responsible for downloading files (updates) from Cloud Server. It will be compliant with GENIVI DUMM component.

### RepoUpdate Component

The RepoUpdate component is responsible for: handling the update process either using data downloaded from Vehicle Backend Server or delivered on a USB stick; managing special storage/data base in which the all images for particular components are stored; and creating temporary updates storage for upgrading process purposes. Whole information about the update procedure is illustrated in FIG. 64, which depicts a tree showing the vehicle environment (structure). Example tree is shown below.

The Update Process starts from the top of tree and ends in the top of tree passing through the node at bottom after making updates of each indirect node in current branch. Here we can have two modes of update: Full update (this mode goes through all nodes making an update of each node); and Partial update (makes an update of nodes which currently needs to be updated). The mode of update will be distinguished by update notification content sent from Manufacturer server. Almost each of the tree nodes contain five groups of scripts (refer to table below for details): Check script, Pre-Update script, Update script (Vehicle node may not have it), Post-Update script, and Recovery script.

TABLE 7
Script Types

| Script | Description |
|---|---|
| Check | Responsible for verification integrity of particular node. |
| Pre-Update | Responsible for preparing proper environment, for pre- |
| | configuring H/W, etc. |
| Update | This script is responsible for upgrading. |
| Post-Update | In case of proper upgrade, this script will be invoke to |
| | clean up all environment. |
| Recovery | In case of error, this script will be invoked to initiate the |
| | Recovery Procedure. |

All of the above scripts will be executed in case of a full update. In partial update there are an additional partial update scripts for each of above groups. In such case the partial update script will be executed instead of normal update script as shown in FIG. 65.

The EI node also has the data file which is used in update process. The normal and partial scripts define the update flow which manages the sequence of branch processing. The current version for all nodes is stored locally within the system. After receiving the update information the temporary tree will be recreated. Downloaded updates go to the correct nodes (each node has individual id, so-called UUID) in following manner: The links to old version of scripts are replaced with new version of scripts in temporary node; Data files are saved in temporary node; and Partial update scripts are saved in temporary node. After successfully completing the update all files (excluding partial update files) are saved in original tree. In case of any error the recovery scripts will be launched and the old tree will remain unchanged.

FIG. 66 illustrates an algorithm of an upgrade process.

Example of a Successful Update Single EI: In this case, RepoUpdate has information about updating the EI node. The update files are saved in indirect nodes. All indirect nodes contain the partial update scripts which overwrite the normal update flow.

FIG. 68 depicts an update procedure. FIG. 69 depicts an example of a successful update of two EIs. In this case, RepoUpdate has information about updating the two EI nodes. The update files are saved in indirect nodes. All indirect nodes contain the partial update scripts which overwrite the normal update flow. The update procedure is shown in the sequence of FIG. 70. FIG. 72 depicts an example of an unsuccessful update of two EIs. In this case, RepoUpdate has information about updating the two EI nodes. The update files are saved in indirect nodes. All indirect nodes contain the partial update scripts which overwrite the normal update flow. The second EI node is not updated successfully. An update procedure is show in the sequence diagram of FIG. 71.

### USB Drive Monitor

USB Drive Monitor is responsible for monitoring USB bus for appearance of storage devices. This functionality allows for updates to be delivered on a USB stick rather than using a download from the server mechanism. Whenever a storage device, connected to USB bus, appears in the system, the following actions are taken: Mount the volume under system wide accessible path; and Search the volume for existence of JSON update files. The exact pattern of allowed upgrade file name is obtained from CarInfo component. Once an upgrade file candidate is located a DBus signal is sent out, which should be subscribed to by interested components such as RepoUpdate. USB Drive Monitor does not attempt to handle errors such as USB drive disconnected in any other way than a cleanup of corresponding mount points. Components accessing the storage are responsible for their IO error handling.

### UI Component

This is a very simple component that is needed to provide some of information as well as status to user. It can also take some user input and provide it to Controller component.

### Release Packages

Various structures of an ECU release package are contemplated, including the following.

[Field 1] Bytes 0-7: Package Size (in bytes)—This is the total number of bytes within the release package image, including the checksum. [Field 2] Bytes 8-19: release package Structure Version Number—This is the version number of the release package structure. [Field 3] Bytes 20-31: ECU release package Version Number—This is the version number of the ECU release package. [Field 4] Bytes 32-35: ECU Manufacturer—This is an enumerated type representing the ECU Manufacturer. [Field 5] Bytes 36-39: ECU Class—This is an enumerated type representing the ECU Class (i.e. which Vehicle Subdomain does the ECU belong to), where the ECU Class is an enumerated value from the following list: Telematics & Infotainment; Body & Comfort; Chassis; Safety & Security; Powertrain. [Field 6] Bytes 40-43: ECU Type—This is the specific “type” of ECU regardless of its class. [Field 7] Bytes 44-51: ECU Identifier—This is the ECU Identification Value. [Field 8] Bytes 52-55: Number of release package Objects—This specifies the number of objects within the package; where an object can be defined as any sequence of bytes that is used within the system as an independent entity. Examples of release package Objects are: Executable Images, Data Configuration Images/Files, Programming Scripts, etc.

[Field 9] Bytes 56-59: release package Object Type—This is enumerated type for different kinds of images, scripts, and independent objects; having one of the following values: 0 (First Stage Bootloader); 1 (Second Stage Boot Program); 2 (Third Stage Boot Program); 3 (Primary Application); 4 (Secondary Application (ex. Diagnostic Function)); 5 (Peripheral Device Executable); 6 (Configuration Data File); 7 (UDS Script File); 8 (Other Script File).

[Field 10] Bytes 60-67: release package Object Identification Number—This is a unique number that will uniquely identify a specific release of a specific release package Object. [Field 11] Bytes 68-75: release package Object Version Number—This is the version number of the release package Object. [Field 12] Bytes 76-83: release package Object Offset—This is the relative offset of the beginning of the image from the beginning of the aggregated release package. If the number of images, scripts, etc. and represented by ‘n’, is greater than 1, then for the fields, [0216] through [0218], they are repeated n−1 times. [Field 13] The last field within the package is always a four-byte checksum.

Messages exchanging via RabbitMQ in certain solutions will be in JSON format. FIG. 73 depicts JSON Messages defined for RabbitMQ.

Format of general request message may include: [string] VIN number of vehicle; [number] Flag for marking if the message is divided into several sub messages or not (0—one message, 1—partial message; 2—last message; see the MsgSeqNo field) [number] Sequence number for partial messages (may start from 0; iIn case of MsgPartial flag equals to 0 the value of this field is not processed); [string] Request type from predefined set.

FIG. 43 depicts a Partial Message Communication.

Additional aspects of messaging may include: [string] refers to the current release package; [object] vehicle object; [string] Current version of vehicle node in format “Major.Minor.Test.Engr”, where major, minor and build are number starting from 0; valid version starts from 0.0.0.0; [number] helper ID for Json object for identification current object in Json string, ID is a number starting from; [number] ID that define the Json parent object for particular object in Json string; 0 value means that there is no parent object (the object is the root); [array] array with subdomain objects; [array] array with ECU objects; [array] array with EI objects; [number] helper ID for Json object for identification current object in Json string, ID is a number starting from 1; [number] ID that define the Json parent object for particular object in Json string; 0 value means that there is no parent object (the object is the root); [string] Current version of vehicle node in the standard Revision Control Version Number Format (see format “Major.Minor.build”, where major, minor and build are number starting from 0; valid version starts from 0.0.0; [string] UUID1 [array] array with FILE objects; [string] points whether the partial or the complete update of the node will take place; [string] format; [string] encryption; [string] valid only when Encryption is not none; [string] URL link returned by the server to download the specified update script/data; [number] gives information about the position in the collective USB update file where to look for the specified update script/data

For example, a vehicle may generate the following request: Vehicle (4c6d84a0-2285-4653-0001-000000000001); Subdomain (4c6d84a0-2285-4653-0002-000000000001); ECU (4c6d84a0-2285-4653-0003-000000000001); EI (4c6d84a0-2285-4653-0004-000000000001); ECU (4c6d84a0-2285-4653-0003-000000000002); EI (4c6d84a0-2285-4653-0004-000000000002); EI (4c6d84a0-2285-4653-0004-000000000003); Subdomain (4c6d84a0-2285-4653-0002-000000000002); ECU (4c6d84a0-2285-4653-0003-000000000003); EI (4c6d84a0-2285-4653-0004-000000000004)

### USB Update File Format

FIG. 37A depicts a General update file format. FIG. 37B depicts a “File header” block. FIG. 37C depicts a “VIN numbers” block. FIG. 37D depicts a “Json car confs” block. FIG. 37E depicts a “Data” block. FIG. 37F depicts a “Data” block details. FIG. 38 depicts a general update file format using encryption.

### DIFF Tools in Certain Embodiments

BSDIFF is a tool for building and applying patches to binary files. BSDIFF performance is quite impressive when comparing to other delta tools. BSDIFF tool compression performance is excellent but, its main disadvantage is significant memory requirements. Thus, a number of changes have been made to the code base of BSDIFF in order to minimize its memory requirements. The following modifications were performed.

Adjustment of data blocks: For each data block, the partial diff file is generated and at the end of the process all partial diff files are combined into one diff file (patch). The size of data block can be adjusted at the start of the execution.

Concurrent execution of data blocks: Each data block is executed in a single thread. The maximal number of threads depends on the processor used and the related number of threads. The number of thread can be set at the start of the execution.

Two compression methods are configurable at the start of the execution: Gzip, Bz2.

Two different versions of a diff tool were tested and benchmarked against the original BSDIFF: (1) Tool 1, Modified DIFF tool with proprietary diff algorithm with focus on minimizing the update time when applying a patch; and Tool 2, Modified DIFF tool with proprietary diff algorithm with focus on minimizing the size of a patch.

Three different test scenarios, that represent typical file/image types, were uses: Scenario 1—SOTA (Original file and Update file are standard Linux installable release package files (RPM)); Scenario 2—FOTA with compressed firmware (Original file and Update file are a compressed image of the whole Tizen partition. The partition sizes for both files are the same); and Scenario 3—FOTA with uncompressed firmware (Original file and Update file are raw images of the entire bootloader partition. The partition sizes for both files are the same).

The first test procedure is to create the patch as diff file between Update and Original file. The second test procedure is to apply the patch on the device to update from Original to Update file.

In case of small SOTA (Software over the air) files, the performance differences were not significant and all results are comparable. In case of large compressed FOTA (Firmware over the air) files, the performance differences are significant. Performance of proprietary diff tools was significantly better then BSDIFF tool saving both upload time and RAM memory consumption. Proprietary diff tools needed 6-7 minutes and 30 MB of RAM to create the diff file, while BSDIFF needed 45 minutes and 1.5 GB of RAM to create the diff file. The Tool 1 diff tool took only 9 seconds to update the system with compressed FOTA file, while it took almost 1 minute for BSDIFF to do the same. In case of large uncompressed FOTA file the performance differences are dramatic. BSDIFF tool was not able to create the patch at all, and consequently the test needed to be aborted, while Tool 1 and Tool 2 diff tools achieved 99.8975% and 99.9921% compression efficiency, respectively, and the update process required only a fraction of seconds.

The proprietary diff tool offers the following advantages: It can be configured before the execution of the delta process to meet specific project requirements; It significantly reduces memory requirements comparing to the original BSSDIFF; It significantly reduces the size of the diff files as compared to the original BSDIFF; It significantly reduces the update time on the target system.

### Management System in Certain Embodiments

CarSync distributed Management System sub-systems are briefly described below.

Distributed message broker supports multiple message queuing protocols, including AMPQ, STOMP, MQTT, ZeroMQ, and RESTful messaging. It can handle over 1 billion messages per day. Its major function is to handle all communications between vehicles and the Management System (including notifications and broadcasting messages). Distributed database is implemented in noSQL technology to be extremely scalable and with low latency. Its major function is to store information about updates and collect report data from vehicles. Distributed file system is a high availability, scalable distributed file system that can store up to several petabytes on commodity hardware. Its major function is to store the updates (files) and deliver them to vehicles. Distributed Vehicle Backend Server: is a very efficient backend application implemented in Erlang language, as are most of the other CarSync distributed Management System sub-systems. Its major function is to control and manage the entire system. North API for 3rd parties integration is implemented as a RESTful interface with JSON as a serialization mechanism. Its major function is to enable easy integration with 3rd party applications and systems. OTA Delivery Service Bus and South API is implemented on a highly scalable routing topology based on a distributed message broker. Its major function is to provide flexible, efficient, automated and extendible South API for connectivity to the In-Vehicle Server.

Distributed Message Broker (MBS): Messaging is a critical capability in various implementations, as it enables software applications to connect and scale. It is an asynchronous communication infrastructure that decouples applications by separating the sending and receiving of data. The message broker provides applications with a common platform for sending and receiving messages, and keeping them in a safe place and live until received.

Some features provided by the distributed message broker infrastructure include: Reliability (It offers a variety of features that can be used to trade off performance with reliability, including persistence, delivery acknowledgements, publisher confirms, and high availability); Flexible (Routing Messages are routed through exchanges before arriving at queues. Exchanges can be bound together for complex routing requirements); Clustering (Several message broker servers on a local network can be clustered together, forming a single logical broker, and allowing for horizontal scaling. To accommodate more vehicles, new nodes can be added); Federation: For servers that need to be more loosely and unreliably connected than clustering allows, a federation model is an option); Highly Available Queues (Queues can be mirrored across several machines in a cluster, ensuring that even in the event of hardware failure all messages are safe); Many Clients (It can support various clients for almost any language, thus providing extensive interoperability); Management UI (It provides an easy-to use management UI to monitor and control every aspect of the message broker); Tracing (It provided tracing capabilities for troubleshooting and monitoring of misbehaved applications); and Plugin Systems (It provides a variety of plugins to for interoperability with heterogeneous protocols and applications).

Distributed Database: In some embodiments, a distributed database that is extremely linearly scalable with low latency is used. It is implemented using noSQL database technology. Its main function is to store information about the updates, and collected reports from vehicles. Depending on the amount of anticipated data, the database can be distributed among several nodes. When implementing the database in a real system, capacity planning needs to be carried out beforehand to ensure that requirements are met. The planning tool is available upon request.

Distributed File System: A distributed file system is designed and implemented to provide network storage that can be made redundant, fault-tolerant and scalable. It also provides high-performance access to large files. Features of one distributed file system include: File-based mirroring and replication; File-based striping; File-based load balancing; Volume failover; Scheduling and disk caching; and Storage quotas. This high availability, scalable distributed file system can store up to several petabytes on commodity hardware. It is used to store the updates (files) that need to be delivered to vehicles.

Vehicle Backend Server: The Vehicle Backend Server includes both the North and the South APIs. The North API provides the interface to 3rd party systems for easy integration.

Functions of the Vehicle Backend Server include: Software version management (Definition of new software versions; Preparation of software packages for delivery; Querying the software version installed in vehicles); Status and errors reporting; Definition of statistical queries and results. The South API may be an internal interface used by certain systems disclosed herein and enabled vehicles. Both interfaces, North APIs and South API are described in more details below.

North API for 3rd Parties Integration: In contrast to South API, which may remain an internal part of various systems disclosed herein, the North API allows for interaction with 3rd party systems. The North API may include two interfaces: HTTP JSON interface (used for message exchanging; it is provided in the form of a RESTful interface with JSON as a serialization mechanism); and FTP interface (used to upload/download Release Packages to CarSync Vehicle Backend Server). Various APIs are contemplated, including: Here is the list of currently defined and implemented APIs in CarSync: ping; add new group; remove group; activate group; rename group; read group info; read group info get vehicles; read group info by RP-UUID; move vehicle between groups request; add new vehicle; remove vehicle; read vehicle information; create new update file; get UF info; find UFS by name; find UFS by provider; add new version to update file; activate new version of update file; drop new version of update file; get version information from update file; create new release package; release package mark as invalid; get release packages for group; release package information.

OTA Delivery Service Bus and South API: OTA Delivery Service Bus is implemented on highly scalable routing topology based on distributed message broker and it includes very flexible, efficient, automated and extendible implementation of South APIs for connectivity to In-Vehicle Server. The South API protocol is implemented to meet the following requirements: stateless protocol (each message should convey enough information to perform certain actions as connectivity may or may not be present); message authentication (it should be possible to authenticate the sender of the message); and efficient serialization mechanism. The South API is implemented as an indirect interface between the Backend Server and vehicles, and provides the following capabilities: Sending reports and statistics by vehicle to the server; Requesting data from the server by vehicles; and Broadcasting messages to particular or all vehicles by the server. The messaging plane may consist of a number of clustered message brokers, reachable through reverse proxy for load balancing. The cluster exposes a set of exchanges and queues for transferring messages from backend server to vehicles (e.g., using one queue) and back (using the same or another queue).

The communication between vehicles and backend is performed in request-response fashion, with exception of notification and report messages, which are unidirectional. Each message conveyed to or from the server contains basic vehicle identification information such as VIN and timestamps, allowing for logging of communication exchange at the server side. The wire format makes use of Google Protocol Buffers, a widely used and supported serialization method that allows efficient packing and convenient protocol evolution. The payload of the messages can be encrypted and signed. This helps to prevent the disclosure of sensitive data such as software versions. At the same time, the message can be authenticated using cryptographic signature methods.

Various message types are contemplated as follows.

Report messages: The report messages are used for sending notification to the server about the progress of certain operations on the device or for sending auxiliary data such as GPS information, statistics etc. RPC messages: RPC messages are sent by vehicle to the server for the purpose of obtaining pieces of information. Contrary to report and notification messages, only one request may be sent in a single message. RPC messages are grouped by the functionality. Configuration request and response message: Used for querying the server for the information on the latest or a particular version of Release Package (RP) for given VIN. The request message conveys information about the current RP as installed in the vehicle. The release package uniquely identifies the states of respective FW or SW package trees. The response message contains the latest RP version with optionally the list of packages/firmware that need upgrading. Authorization token message: Used for obtaining the token that is required when accessing a remote location where either an Update File or the actual firmware/software package file is published. The token can have a form of a string that has to be added to HTTP headers when making a request. Authorization token can be obtained using GetAuthToken structure.

Encryption key message: Used to obtain or update the keying material for decrypting package data. Notification messages: Notifications messages can be issued by the Vehicle Backend Server to the vehicles. The purpose of the notification message is to trigger an action on vehicle's side. The message may be targeted for some or all vehicles. In any case, the vehicles are responsible for checking the VIN field and matching own VIN against the defined value/mask. Auxiliary messages: These are messages described in other documents that follow the same encoding mechanism as South API protocol messages. Update File metadata is an example.

### Use Cases

Backend: Providing scalable architecture; Providing notification mechanism; Providing channel for exchanging messages with vehicles; Providing channel for reporting data by vehicles; Provide a Web UI interface to Tier1/OEM.

Communication: Sending notification to vehicles about new update; Sending reports, logs, configuration, statistics, etc., by vehicles to BE; Proving information about the best BE address; Forcing downloading new update data; Providing possibility of requesting some data from BE by vehicle; Providing light way of communication; Providing protocol for exchanging messages that uses JSON

Messages: Proving such types of messages: request, responses, reporting and notification(broadcast) messages; Every request message should be followed by response message; Request messages should provide various possibilities (Reporting current vehicle configuration; Retrieving AES content key; Retrieving special authentication token which is required in communication with GlusterFS; Retrieving the best address of server for communication for particular vehicle; Vehicle identification).

Various scenarios (i.e., use cases) may be contemplated. Accordingly, the aspects described herein may be implemented in relation to the following use cases: Vehicle configuration update utilizes virtual connection between VCCS and LVC-CS; Vehicle Configuration Proxy Server connects to VCCS as a “proxy” for the LVC-CS to the VCCS; Vehicle Configuration Proxy Server connects to the LVC Server as a “proxy” for the VCCS; Vehicle Configuration [Cloud or Proxy] Server notifies vehicle that updates may be ready to be downloaded, and notification mechanism may or may not be dependent upon or related to download technology; VCCS connects to Vehicle Gateway Interface via SIRIUSXM Satellite Link; VCCS connects to Vehicle Gateway Interface via Cellular network on Smart Phone connected to VGI either through Wi-Fi, Bluetooth, USB cable or other means; Smart Phone Connection acts as pass-through data bridge for cellular connection; Smart Phone Connection acts as data collection point for cellular connection. Subsequently downloads at user discretion to VGI either through Wi-Fi or USB cable; VCCS connects to VGI via OnStar proprietary cellular network; Vehicle Configuration Proxy Server connects to VGI via OEM specified Wi-Fi “Hot Spot” (e.g., at dealer location) and OEM specified “Hot Spot” could be for those whose home network may be not in range of their vehicle (e.g., high-rise occupants whose parking garage may be out-of-range); VCPS connects to VGI via vehicle owner specified Wi-Fi “Hot Spot” (e.g., vehicle owner's home); Vehicle Configuration Proxy Server connects to vehicle owner USB Thumb-drive. USB Thumb-drive may be then inserted into VGI USB port; Vehicle Configuration [Cloud or Proxy] Server link takes multiple iterations to complete vehicle configuration update without resending any previously sent data (i.e. data may be aggregated and stored and LVC remembers what it last received); LVC-CS updates itself with most recent download; LVC-CS regress back one version (i.e. to secondary copy) after either detecting user direction to do so or detecting current version corrupted (NOTE: secondary copy may be re-designated as primary copy; prior primary copy may be re-designated as secondary copy); LVC-CS may be interrupted by power loss during update (NOTE: updates always overwrite the secondary copy so that the primary copy may be intact until the updated copy in the secondary copy's area may be verified; at which point the primary copy becomes the secondary copy); LVC-CS must have ability to regress two (2) or more versions back (NOTE: LVC-CS must “request” specific release package from VCCS); LVC-CS updates subordinate ECU with complete ECU release package; LVC-CS updates subordinate ECU with ECU Abbreviated release package.

Systems and methods in accordance with certain aspects may be an extended Configuration Management & Delivery Ecosystem that provides a complete end-to-end solution from an Internet Cloud Server down to a Vehicle Server that maintains and then distributes Electronic Image (EI) updates of Electronic Control Units (ECUs) within automotive vehicles, but may also be applied for other sets of EIs and applications, not just automotive; particularly wherever there are a disparate, but related group of different hardware (with respect to hardware manufactures) centered around a core application that may meet some common communication and operational standard in order for them to all integrate into a larger, but common, eco-system.

One ecosystem organizes, manages, and transfers: Electronic Images (EIs) residing within the Electronic Control Units (ECUs) of automotive vehicles. ECU sets of EIs, whose elements are specified herein and are grouped as a complete set of EIs specific to a particular ECU. Vehicle Subdomain sets of ECU EI sets, whose elements are specified herein and are grouped as a complete set of ECUs within a specific Vehicle Subdomain. Vehicle Domain sets of Vehicle Subdomain sets, whose elements are specified herein and are grouped as a complete set of Vehicle Subdomains within a specific Vehicle Domain. Currently, vehicle control systems are divided into three vehicle subdomains: a) Telematics & Infotainment; b) Body & Chassis; and c) Engine Bay. These three vehicle subdomains comprise a single, complete Vehicle Domain. EI's, EI ECU sets, EI Vehicle Subdomain sets, and EI Vehicle Domain sets; according to some cross section of the aforementioned for organizing EIs for specific Aftermarket Telematics & Infotainment Head Unit ECUs.

One ecosystem maintains: EIs according to an organizational structure that may be capable of being Vehicle OEM centric for organizing all of the ECUs and their EIs of a particular Vehicle OEM across all applicable makes, models, and model years. EIs according to an organizational structure that may be capable of being Aftermarket Manufacturer centric with the central organizing entity being the Aftermarket Manufacturer's Telematics & Infotainment Head Unit. EIs within the vehicle without any foreknowledge of the other ECUs nor their EIs; and using only the predefined organizational structure as the primary means for delineating and organizing the EIs within the overall Vehicle ECU EI database. E.g., One and only one unique copy of EIs regardless of diversity of the number of ECUs it might be found in. The BIOS may be an example of an Electronic Image which may appear in multiple ECUs, but need only one copy maintained across the entire EI database.

One ecosystem requires an accepted EI structure (as referenced herein that may be an Arynga devised scheme and includes specific information required to identify Electronic Images (EIs) (these are the “core” elements being managed within the system. All other structures are either supporting elements of EIs or they have additional hierarchical information in organizing sets of EIs. These additional elements are as follows: ECU sets of EIs; Vehicle Subdomain sets; Vehicle Domain sets; EI Programming Scripts, where these scripts are always some form of Uniform Diagnostic Service (UDS) script, with top two UDS scripts supported are from: VectorCAN; and AutoSAR. There may be a one-to-one relationship between a specific EI and a specific ECU with regard to an EI scripts. Meaning, each UDS script may be unique to that ECU for that particular EI. ECU Programming Scripts for specific ECU sets. This may be a TBD scripting language whose primary, but not sole purpose, may be to specify the order for which the EIs get programmed within a particular ECU. That is, it may be the this script specifies the order the UDS scripts specified herein are executed. Vehicle Subdomain Programming Scripts for specific Vehicle Subdomain sets. This may be a TBD scripting language, whose primary, but not sole purpose, may be to specify the order for which ECUs are programmed within a particular Vehicle Subdomain. That is, it may be this script that specifies the order the ECU programming scripts specified herein are executed. Vehicle Domain Programming Scripts for specific Vehicle Domain sets. This may be a TBD scripting language, whose primary, but not sole purpose, may be to specify the order for which Vehicle Subdomains are programmed within a particular Vehicle Domain. That is, it may be this script that specifies the order the Vehicle Subdomain programming scripts specified herein are executed.

One ecosystem may use and augments the existing verification & validation EI certification system of a Vehicle OEM in order to organize, maintain, and subsequently distribute EIs across ECUs within a specific vehicle regardless of ECU type so long as the ECU manufacturer provides a specific minimum set of information regarding each EI within the an associated ECU, including specific relationship information with regard to V&V and releases between the ECU EIs. This may be required for all Hs within all ECUs that are to participate within a Configuration Management & Delivery Eco-System. Specific information required by one ecosystem for each ECU EI/ECU pair may be as follows: Each EI may have a unique release number that allows an iteration of the EI to always be identified, referenced, and differentiated from other prior or subsequent EI iterations; An absolute offset of each EI image in ECU memory; A UDS script that controls and specifies the downloading sequence of a specific EI into the specific ECU. This script more than likely includes the absolute offset referenced herein.

Additional features may relate to: An EI may or may not be transmitted from the Cloud Server without being encapsulated by a release package Wrapper; A Differential release package only contains those individuals elements within the release package that are physically different than the immediate prior version of the same release package.

Non-Primary ECU Update Process—certain systems and methods take UDS Download Scripts that enable an external device to both all the ECUs on a given CAN bus (or other physical medium within the vehicle) network and download code to a specific ECU. Such scripts may be used by external devices that are connected to the car via a diagnostic port. Logic that runs these scripts may be moved into an existing MASTER ECU. Tier 1 ECU manufacturers may provide these scripts to the OEMs so that they can have their diagnostic equipment manufacturers utilize these scripts for updating ECUs in the field and in the repair centers. Additionally, and in order for these scripts to be effective, the ECUs may have hooks all the down into the Boot Loader code that allows this mechanism to operate and take control of the ECU at the most basic level.

Primary ECU Update Process—This may be the process that updates the “Master ECU”. The Master ECU may be the device being used to program all of the other ECUs. Thus, unlike when it may be updating “other” subordinate ECUs, when it updates itself, it does not have to utilize an external network to update itself. Compared to scripts from a non-primary ECU scripts, certain scripts may take advantage of the fact that the Master ECU may ALWAYS maintain the more two recent COMPLETE versions of core software release package. Thus, it can update itself in real time without affecting the existing release package since it can overwrite the “OLD” (or “alternate”) copy without adversely affecting the current (or “primary”) copy.

### Applications

Various features have been described herein to support the automotive industry requirements for extended life cycle management and applications for connected vehicles and for connected and intelligent transportation. Such features include collection of information at a vehicle, transfer of information between vehicles and other things (e.g., other vehicles, government or commercial entities, nearby computing devices, remote computing devices, and others), dissemination of information inside a vehicle, uploads, downloads, and other features.

Various applications exist for the features described herein, including the following applications: Telematics (real time parking information, driver assistance, eMobility solutions, CarzX solutions, car diagnosis, eCall, remote door lock/unlock, eCall, bCall, floating car data, stolen vehicle recovery); Communication (hands-free telephony, text messaging and email, CarzX communication, WiFi hotspot); Location (hybrid-navigation, map updates, vehicle tracking, fleet management, geo-fencing); Information (points of interest, web access & browsing, weather & stock information, real time traffic information, concierge services); Social networking (share my trip, car sharing, car sharing, car Facebook, car search, car twitter); eCommerce (city toll, road toll, payment solutions, parking space reservation, pay as you drive); and Entertainment (e.g., music streaming, online games, VoD, web radio, environmental browsing.

These applications may be supported by a complex ecosystem, including: an application layer for services and functions (e.g., data analytics, knowledge generation); a presentation layer (e.g., human input/output, measuring devices like sensors, controls like actuators); a session layer (e.g., factory installed devices, aftermarket devices, mobile devices); network/transport layer (PAN, LAN, WAN); and physical layer (cellular, cable, other communication channels for data transmission). Various entities may make use of the ecosystem (OEM, suppliers, cloud service provider, other service provider, web company, government, others). Various aspects disclosed herein create a vehicle solution that can integrate into legacy infrastructure.

Various features may be needed for an end-to-end connected vehicle solution, including: backend office system to manage the distribution and updates of OEMs software and firmware elements and applications present in each vehicle, including access to vehicle data for various applications; and in vehicle system to manage software and firmware update process for all software and firmware resident in vehicle ECUs, bug fixing, and access to car and driver data.

Implementations of features disclosed herein can: handle very large number of concurrent activities, with ability to run many services in a single node; be easily distributable over a network of computers, and there is no hardcoded network topology; be fault-tolerant to both software & hardware errors, as there is no single point of failure (e.g., peer-to-peer system); scale with the number of machines on the network, and more resources can be added as needed; be upgradable & reconfigurable without having to stop & restart (hot code replacement); be easier upgradable, as old services can be bring down and new can be started dynamically; removed services become unregistered, and new ones are discovered as they come online; discovery is location transparent and it works just as well with only one node or many; be responsive to users within certain strict timeframes; and stay in continuous operation for many years.

### Example Methodologies

Functionality disclosed herein may be embodied as one or more methods implemented by processor(s) at one or more many locations. Non-transitory processor-readable media embodying program instructions adapted to be executed to implement the method(s) are also contemplated.

By way of example, not by way of limitation, any number of methods may comprise: identifying a first set of update files received by the automotive electronics system from an external source during a first period of time; identifying a second set of installed files that correspond to the update files of the first set; and for each update file of the first set that corresponds to an installed file of the second set, causing that update file to replace that installed file only when a version of the update file is different that a version of the installed file. Methods may further or alternatively comprise: for each update file of the first set that corresponds to an installed file of the second set, causing that update file to replace that installed file only when the version of the update file is greater than the version of the installed file. In accordance with some aspects, the first set of update files includes a first update file indicating that a first installed file of the second set is to be uninstalled. Methods may further or alternatively comprise: causing the first installed file to be uninstalled based on the first update file. In accordance with some aspects, the first set of update files includes an additional update file that does not correspond to any installed file of the second set. Methods may further or alternatively comprise: causing the additional update file to be installed. Methods may further or alternatively comprise: for each installed file with a different version than a version of a corresponding update file, identifying a vehicle node that corresponds to that installed file prior to replacing that installed file with that corresponding update file; determining if that vehicle node is active; and causing that update file to replace that installed file only when that vehicle node is inactive. Methods may further or alternatively comprise: determining if an engine of the motorized vehicle is off prior to replacing certain installed files with corresponding update files; and causing that update file to replace that installed file only when the engine is off. Methods may further or alternatively comprise: determining, before replacing a first installed file with an update file, whether the update file is compatible with a second is installed file.

In accordance with some aspects, at least one of the update files includes an identifier of an electronic control unit to which the update file relates. In accordance with some aspects, at least one of the update files includes an identifier of a manufacturer of the electronic control unit. In accordance with some aspects, at least one of the update files includes an identifier of a vehicle subdomain within which the update file is to be installed.

Any of the various aspects described herein may be applied to mass distribution of software updates in a non-motorized vehicle setting. Various computer networks may benefit from implementation of the disclosed aspects within their networks to update disjoint, heterogeneous electronic control units. For example, various aspects may be used in conjunction with factories or smart utilities (e.g., transformers and other remotely located power equipment) to distribute updates to and from different parts of the network where various network components can distribute and receive updates (e.g., where a transformer obtains software updates from one or more nearby or passing cars at different times).

In certain embodiments, one or more automotive electronic systems of motorized vehicles may be configured to carryout various methodologies. Example method(s) may: receive data transmitted from one or more external sources over an aggregate time period, wherein the data includes a first amount of data received during a first time period of the aggregate time period, and further includes a second amount of the data received during a second time period of the aggregate time period.; request the first amount of data (e.g., one of many bytes of data) upon determining that the first amount of data has not been received by the first motorized vehicle; determine, after requesting the first amount of data, whether the first motorized vehicle received the first amount of data from the one or more external sources (e.g., by checking a downloaded byte offset value that identifies either the last downloaded byte or the next byte to be downloaded based on the byte number); request the second amount of data (e.g., a subsequent byte of data) when the first motorized vehicle received the first amount of data; determine, after requesting the second amount of data, whether the first motorized vehicle received the second amount of data from the one or more external sources; determine, when the first motorized vehicle received the second amount of data, whether one or more other amounts of the data exist; and determine, when the one or more other amounts of the data exist, whether the first motorized vehicle received the one or more other amounts of the data from the one or more external sources.

The method(s) may: determine that the first motorized vehicle did not receive the first amount of data when the first amount of data is not stored in a data storage component of the system; and determine that the first motorized vehicle received the first amount of data when the first amount of data is stored in the data storage component of the system. The method(s) may: determine that the first motorized vehicle did not receive the first amount of data when a first condition at the first motorized vehicle is met; and determine that the first motorized vehicle received the one or more other amounts of the data when a second condition at the first motorized vehicle is met. The method(s) may: determine that the first motorized vehicle received the first amount of data when a first condition at the first motorized vehicle is met during a first period of time; and determine that the first motorized vehicle did not receive the one or more other amounts of the data when a second condition at the first motorized vehicle is met during a second period of time.

The first period of time and the second period of time may be separated by a plurality of hours. The first period of time and the second period of time may be separated by a third time period defined by an amount of time during which the first motorized vehicle may be unable to receive the one or more other amounts of the data. The first period of time and the second period of time may be separated by a third time period defined by an amount of time during which the system may be powered down. The first period of time and the second period of time may be separated by a third time period defined by an amount of time during which the one or more external sources may be powered down. The first period of time and the second period of time may be separated by a third time period defined by an amount of time during which there may be no suitable communication pathway connecting the system to the one or more external sources. The first motorized vehicle may be located at a first location during first period of time and a second location during the second period of time.

The first amount of data may include a first byte of a plurality of bytes, the second amount of data includes a second byte of the plurality of bytes, and the plurality of bytes specify a software or firmware update for an electronic component of the automotive electronic system of the motorized vehicle. The first amount of the data may be received from a first external source, and the second amount of the data may be received from a second external source The first external source and the second external source may be at geographically different locations. The first amount of the data may be received using a first communication pathway, and the second amount of the data may be received using a second communication pathway The first and second communication pathways may be different. The first and second communication pathways may be selected from the group pathway types consisting of a GPS pathway, a Wi-Fi pathway, a cellular pathway, a USB pathway, and a Bluetooth pathway, and wherein the first and second communication pathways may be different pathway types.

The first and second communication pathways may be selected from the group of pathway types consisting of a wireless pathway and a wired pathway, and wherein the first and second communication pathways may be different pathway types. The first and second communication pathways may be selected from the group of pathway types consisting of a first communication pathway between the first motorized vehicle and a moving motorized vehicle, a second communication pathway between the first motorized vehicle and a stationary motorized vehicle, a third communication pathway between the first motorized vehicle and a fixed transmitter, a fourth communication pathway between the first motorized vehicle and a portable computing device operated by a user, and a fifth communication pathway between the first motorized vehicle and a local area network, and wherein the first and second communication pathways may be different pathway types.

The first motorized vehicle may be further configured to simultaneously receive a third amount of the data using a third communication pathway and the first amount of data using the first communication pathway The first and third communication pathways may be of different types of pathways selected from the group pathway types consisting of a GPS pathway, a Wi-Fi pathway, a cellular pathway, a USB pathway, and a Bluetooth pathway.

The first and third amounts of data include data associated with a software or firmware update for an electronics control unit of the automotive electronic system. During the simultaneous download, each electronics control unit may process an identifier for discrete update data to determine which update may be intended for the vehicle of that control unit. For example, the electronic control units may interpret header information of each update to confirm whether the update applies to that electronic control unit's vehicle (e.g., the header may include some or all of the vehicle's VIN). Alternatively, distribution of the same update may be made to a group of vehicles so no processing may be needed or a header or other identifier.

The first amount of data includes data associated with a first software or firmware update for a first electronics control unit of the automotive electronic system, and the third amount of data includes data associated with a third software or firmware update for a third electronics control unit of the automotive electronic system.

The first and second amounts of the data both include data associated with a software or firmware update for an electronics control unit of the automotive electronic system.

The first amount of data specifies a software or firmware update for an electronic component of a second motorized vehicle The automotive electronic system further comprises: an output configured to transmit the first amount of data to the second motorized vehicle.

The data may represent an update to software or firmware used by an electronics control unit of the automotive electronic system, and the one or more processing components may be further operable to: cause the electronics control unit or a another one or more processing components connected to the electronics control unit to replace a portion of the software or firmware used by the ECU with the update; cause a data source to maintain a copy of the portion of the software or firmware used by the ECU that may be replaced by the update; and upon detecting that the update may be corrupted or that operation of the electronics control unit associated with the update provides an undesired result, replace the update with the portion of the software or firmware stored in the data source.

The method(s) may: detect that the update may be corrupted by determining that the update may be missing data.

The method(s) may: detect that operation of the electronics control unit associated with the update provides an undesired result by correlating the undesired result to a desired result.

In accordance with at least one aspect, a system for transmitting software/firmware updates to one or more motorized vehicles using one or more communication pathways may comprise one or more processing components operable to: detect, during a first period of time, a first motorized vehicle at a first location within a first range of a first communication pathway; determine a first portion of data representing a first software/firmware update to transmit to the first motorized vehicle; and causing the transmission of the first portion of the data through the first communication pathway during the first period of time.

The method(s) may: detect the first motorized vehicle at the first location within a second range of a second communication pathway; determine a second portion of the data representing the first software/firmware update to transmit to the first motorized vehicle; and causing the transmission of the second portion of the data to the first motorized vehicle through the second communication pathway. The transmissions of the first and second portions of the data may be simultaneous.

The first and second communication pathways may be selected from the group pathway types consisting of a GPS pathway, a Wi-Fi pathway, a cellular pathway, a USB pathway, and a Bluetooth pathway, and wherein the first and second communication pathways may be different pathway types.

The first and second communication pathways may be selected from the group of pathway types consisting of a wireless pathway and a wired pathway, and wherein the first and second communication pathways may be different pathway types.

The first and second communication pathways may be selected from the group of pathway types consisting of a first communication pathway between the first motorized vehicle and a moving motorized vehicle, a second communication pathway between the first motorized vehicle and a stationary motorized vehicle, a third communication pathway between the first motorized vehicle and a fixed transmitter, a fourth communication pathway between the first motorized vehicle and a portable computing device operated by a user, and a fifth communication pathway between the first motorized vehicle and a local area network, and wherein the first and second communication pathways may be different pathway types.

The method(s) may: detect, during a second period of time, the first motorized vehicle at a second location within a second range of a second communication pathway The first and second locations may be remote from each other; determine a second portion of the data to transmit to the first motorized vehicle; and causing the transmission of the second portion of the data to the first motorized vehicle through the second communication pathway during the second period of time.

The first and second communication pathways may be selected from the group pathway types consisting of a GPS pathway, a Wi-Fi pathway, a cellular pathway, a USB pathway, and a Bluetooth pathway, and wherein the first and second communication pathways may be different pathway types.

The first and second communication pathways may be selected from the group of pathway types consisting of a wireless pathway and a wired pathway, and wherein the first and second communication pathways may be different pathway types.

The first and second communication pathways may be selected from the group of pathway types consisting of a first communication pathway between the first motorized vehicle and a moving motorized vehicle, a second communication pathway between the first motorized vehicle and a stationary motorized vehicle, a third communication pathway between the first motorized vehicle and a fixed transmitter, a fourth communication pathway between the first motorized vehicle and a portable computing device operated by a user, and a fifth communication pathway between the first motorized vehicle and a local area network, and wherein the first and second communication pathways may be different pathway types.

The method(s) may: detect a second motorized vehicle within a second range of a second communication pathway; determine a second portion of data representing a second software/firmware update to transmit to the second motorized vehicle; and cause the transmission of the second portion of the data to the second motorized vehicle through the second communication pathway.

The transmissions of the first and second portions of the data may be simultaneous. The first and second communication pathways may be selected from the group pathway types consisting of a GPS pathway, a Wi-Fi pathway, a cellular pathway, a USB pathway, and a Bluetooth pathway, and wherein the first and second communication pathways may be different pathway types.

The first and second communication pathways may be selected from the group of pathway types consisting of a wireless pathway and a wired pathway, and wherein the first and second communication pathways may be different pathway types.

The first and second communication pathways may be selected from the group of pathway types consisting of a first communication pathway between the first motorized vehicle and a moving motorized vehicle, a second communication pathway between the first motorized vehicle and a stationary motorized vehicle, a third communication pathway between the first motorized vehicle and a fixed transmitter, a fourth communication pathway between the first motorized vehicle and a portable computing device operated by a user, and a fifth communication pathway between the first motorized vehicle and a local area network, and wherein the first and second communication pathways may be different pathway types.

The method(s) may: detect the second motorized vehicle within the second range of a second communication pathway during the first period of time. The method(s) may: detect the second motorized vehicle within the second range of a second communication pathway during a second period of time. The method(s) may: detect the second motorized vehicle at the first location. The method(s) may: detect the second motorized vehicle at a second location The first and second locations may be remote from each other.

In accordance with another aspect, a method for receiving data specifying a software or firmware update for an electronic component of an motorized vehicle from an external source may perform the following steps: determining, during a first time period, if a first amount of the data may be stored in a data source of the motorized vehicle; requesting, when the first amount of the data may be not stored in the data source, the first amount of the data; receiving, after the first amount of data may be requested, the first amount of data; storing, after receiving the first amount of data, the first amount of data in the data source; determining, after the first amount of the data may be stored in the data source, if all of the data may be stored in the data source; requesting, when all of the data may be not stored in the data source and when the first amount of the data may be stored in the data source, a second amount of the data; receiving, when the second amount of data may be requested, the second amount of data; and storing, after receiving the second amount of data, the second amount of data in the data source, wherein at least one or more processing components performs at least one of the above steps.

The determining if the first amount of the data may be stored in the data source of the motorized vehicle may comprise any of the steps of: determining that the first amount of data may be stored in the data source when a first threshold condition may be met; determining that all of the data may be stored in the data source when a second threshold condition may be met during the first time period; and determining that all of the data may be stored in the data source when a second threshold condition may be met during a second time period.

### Other Aspects

The various illustrative systems, methods, logical features, blocks, modules, components, circuits, and algorithm steps described herein may be implemented, performed, or otherwise controlled by suitable hardware known or later developed in the art, or by firmware or software executed by processor(s), or any such combination of hardware, software and firmware.

Systems may include one or more devices or means that implement the functionality (e.g., embodied as methods) described herein. For example, such devices or means may include processor(s) that, when executing instructions, perform any of the methods disclosed herein. Such instructions can be embodied in software, firmware and/or hardware. A processor (also referred to as a “processing device”) may perform or otherwise carry out any of the operational steps, processing steps, computational steps, method steps, or other functionality disclosed herein, including analysis, manipulation, conversion or creation of data, or other operations on data. A processor may include a general purpose processor, a digital signal processor (DSP), an integrated circuit, a server, other programmable logic device, or any combination thereof. A processor may be a conventional processor, microprocessor, controller, microcontroller, or state machine. A processor can also refer to a chip or part of a chip (e.g., semiconductor chip). The term “processor” may refer to one, two or more processors of the same or different types. It is noted that a computer, computing device and user device, and the like, may refer to devices that include a processor, or may be equivalent to the processor itself.

A “memory” may accessible by a processor such that the processor can read information from and/or write information to the memory. Memory may be integral with or separate from the processor. Instructions may reside in such memory (e.g., RAM, flash, ROM, EPROM, EEPROM, registers, disk storage), or any other form of storage medium. Memory may include a non-transitory processor-readable medium having processor-readable program code (e.g., instructions) embodied therein that is adapted to be executed to implement any number of the various methods disclosed herein. Processor-readable media be any available storage media, including non-volatile media (e.g., optical, magnetic, semiconductor).

When embodied in software, the instructions can be downloaded to reside on and be operated from different platforms used by a variety of operating systems. When embodied in firmware, the instructions can be contained in a semiconductor chip or similar device.

Functionality disclosed herein may be programmed into any of a variety of circuitry that is suitable for such purpose as understood by one of skill in the art. For example, functionality may be embodied in processors having software-based circuit emulation, discrete logic, custom devices, neural logic, quantum devices, PLDs, FPGA, PAL, ASIC, MOSFET, CMOS, ECL, polymer technologies, mixed analog and digital, and hybrids thereof. Data, instructions, commands, information, signals, bits, symbols, and chips disclosed herein may be represented by voltages, currents, electromagnetic waves, magnetic fields or particles, optical fields or particles, or any combination thereof. Computing networks may be used to carry out functionality and may include hardware components (servers, monitors, I/O, network connection). Application programs may carry out aspects by receiving, converting, processing, storing, retrieving, transferring and/or exporting data, which may be stored in a hierarchical, network, relational, non-relational, object-oriented, or other data source.

“Data” and “information” may be used interchangeably. A data source which is depicted as a single storage device may be realized by multiple (e.g., distributed) storage devices. A data source may include one or more types of data sources, including hierarchical, network, relational, non-relational, object-oriented, or another type of data source. As used herein, computer-readable media includes all forms of computer-readable medium except, to the extent that such media is deemed to be non-statutory (e.g., transitory propagating signals). The disclosure is not intended to be limited to the aspects shown herein but is to be accorded the widest scope understood by a skilled artisan, including equivalent systems and methods.

Features in system and apparatus figures that are illustrated as rectangles may refer to hardware, firmware or software. It is noted that lines linking two such features may be illustrative of data transfer between those features. Such transfer may occur directly between those features or through intermediate features even if not illustrated. Where no line connects two features, transfer of data between those features is contemplated unless otherwise stated. Accordingly, the lines are provide to illustrate certain aspects, but should not be interpreted as limiting. The words “comprise,” “comprising,” “include,” “including” and the like are to be construed in an inclusive sense (i.e., not limited to) as opposed to an exclusive sense (i.e., consisting only of). Words using the singular or plural number also include the plural or singular number respectively. The words “or” or “and” cover both any of the items and all of the items in a list. “Some” and “any” and “at least one” refers to one or more. The term “device” may comprise one or more components (e.g., a processor, a memory, a receiver, a screen, and others).

1. A method for providing updates to an automotive electronics system residing at a motorized vehicle, the method comprising:
identifying a first set of update files received by the automotive electronics system from an external source during a first period of time;
identifying a second set of installed files that correspond to the update files of the first set; and
for each update file of the first set that corresponds to an installed file of the second set, causing that update file to replace that installed file only when a version of the update file is different that a version of the installed file.

2. The method of claim 1, wherein the method further comprises:
for each update file of the first set that corresponds to an installed file of the second set, causing that update file to replace that installed file only when the version of the update file is greater than the version of the installed file.

3. The method of claim 1, wherein the first set of update files includes a first update file indicating that a first installed file of the second set is to be uninstalled, and wherein the method further comprises:
causing the first installed file to be uninstalled based on the first update file.

4. The method of claim 1, wherein the first set of update files includes an additional update file that does not correspond to any installed file of the second set, and wherein the method further comprises:
causing the additional update file to be installed.

5. The method of claim 1, wherein the method further comprises:
for each installed file with a different version than a version of a corresponding update file, identifying a vehicle node that corresponds to that installed file prior to replacing that installed file with that corresponding update file;
determining if that vehicle node is active; and
causing that update file to replace that installed file only when that vehicle node is inactive.

6. The method of claim 1, wherein the method further comprises:
determining if an engine of the motorized vehicle is off prior to replacing certain installed files with corresponding update files; and
causing that update file to replace that installed file only when the engine is off.

7. The method of claim 1, wherein the method further comprises:
determining, before replacing a first installed file with an update file, whether the update file is compatible with a second is installed file.

8. The method of claim 1, wherein at least one of the update files includes an identifier of an electronic control unit to which the update file relates.

9. The method of claim 1, wherein at least one of the update files includes an identifier of a manufacturer of the electronic control unit.

10. The method of claim 1, wherein at least one of the update files includes an identifier of a vehicle subdomain within which the update file is to be installed.

11. A system comprising one or more processors that perform the method of claim 1.

12. A non-transitory machine-readable medium embodying program instructions adapted to be executed to implement the method of claim 1.
